(19) United States
(12) Patent Application Publication
(10) Pub. No.: US 2012/0328774 A1
(43) Pub. Date: Dec. 27, 2012

(54) CARBON-DEPOSITED ALKALI METAL OXYANION ELECTRODE MATERIAL AND PROCESS OF PREPARING SAME

(75) Inventors: Guoxian Liang, St-Hyacinthe (CA); Christophe Michot, Montreal (CA); Jasmin Dufour, Lemoyne (CA)

(73) Assignee: PHOSTECH LITHIUM INC., Candiac (CA)

(21) Appl. No.: 13/531,257

(22) Filed: Jun. 22, 2012

Related U.S. Application Data
(60) Provisional application No. 61/500,016, filed on Jun. 22, 2011.

(51) Int. Cl. H01M 4/04

(52) U.S. Cl. 427/122

(57) ABSTRACT

The present invention relates to the field of electrode materials, and more specifically, to a carbon-deposited alkali metal oxyanion electrode material as well as to a process for preparing same. More particularly, the process for preparing the carbon-deposited alkali metal oxyanion electrode material comprises a dry milling step of precursors of the alkali metal oxyanion electrode material at an energy sufficient to cause the precursors to agglomerate into strong agglomerates, and a heating step comprising pyrolysis of an organic source to obtain the carbon-deposited alkali metal oxyanion electrode material.

### BACKGROUND OF THE INVENTION

1. Field of the Invention

The present invention relates to the field of electrode materials, and more specifically, to a carbon-deposited alkali metal oxyanion electrode material as well as to a process for preparing same.

2. Description of the Related Art

Some alkali metal oxyanions, useful as cathode material, exhibit undesirably low electronic conductivity. One significant improvement to the problem of low electronic conductivity of some of these alkali metal oxyanion material, for instance of alkali metal phosphate, has been achieved with the formation of a carbon deposit on the surface of the material. Ravet has proposed using an organic carbon precursor that is pyrolysed onto the cathode material or its precursors, thus forming a carbon deposit, to improve electrical field at the level of the cathode particles. [See, e.g., U.S. Pat. No. 6,855,273, U.S. Pat. No. 6,962,666, U.S. Pat. No. 7,344,659, U.S. Pat. No. 7,815,819, U.S. Pat. No. 7,285,260, U.S. Pat. No. 7,457,018, U.S. Pat. No. 7,601,318, U.S. Pat. No. 8,173,049, US 2011/210293, WO 02/27823 and WO 02/27824)].

In the specific case of a carbon-deposited lithium iron phosphate, referred to as C—LiFePO₄, several processes have been proposed to manufacture the material, either by pyrolysis of a carbon precursor on LiFePO₄ or by simultaneous reaction of lithium, iron and PO₄ sources and a carbon precursor. For example, WO 02/027823 and WO 02/027824 describe a solid-state thermal process allowing synthesis of C—LiFePO₄ through the following reaction:

Fe(III)PO₄+½Li₂CO₃+carbon precursor→C—LiFe(II)PO₄

in which the carbon precursor is an organic material that forms a carbon deposit through pyrolysis while generating reducing gases that efficiently reduce the iron (III).

The implementation of such processes at an industrial scale presents some challenges as the properties of the end product may vary significantly from one batch to another. The processes involve a number of simultaneously occurring chemical, electrochemical, gas-phase, gas-solid reactions, sintering and carbon deposition. The electrochemical properties of an alkali metal oxyanion electrode material having a carbon deposit are thus dependent on numerous parameters such as surface properties, wettability, surface area, porosity, particle size distribution, water-content, crystal structure, as well as the raw materials chemistry, reactor feed rate, flow of gas, etc. All those properties are difficult to control in a very precise fashion during the reaction, which results in undesirable fluctuations of the cathode material properties, especially electrochemical capacity (mAh/g).

### SUMMARY OF THE INVENTION

In one broad aspect, the invention relates to a carbon-deposited alkali metal oxyanion electrode material and to a process for preparing same.

In another aspect, the invention relates to a process for preparing a carbon-deposited alkali metal oxyanion electrode material, the process comprising a dry milling step of precursors at an energy sufficient to obtain strong agglomerates of the precursors. The milled precursors are then subjected to a thermal treatment in order to obtain the carbon-deposited alkali metal oxyanion electrode material.

In another yet aspect, the invention relates to a process for preparing a carbon-deposited alkali metal oxyanion electrode material, the process comprising a dry high-energy milling step of precursors. The milled precursors are then subjected to a thermal treatment in order to obtain the carbon-deposited alkali metal oxyanion electrode material.

In one non-limiting embodiment, the herein described dry high-energy milling step is a dry high-energy ball milling step.

In yet another aspect, the invention relates to a process for preparing a carbon-deposited alkali metal oxyanion electrode material, comprising a dry milling step of precursors at an energy sufficient to obtain strong agglomerates of the precursors, where the precursors comprise a metal source. Optionally, the process comprises reduction of the oxidation state of at least one metal ion of the metal source in a thermal treatment without full reduction to an elemental state. The reaction is completed in order to obtain the carbon-deposited alkali metal oxyanion electrode material.

In yet another aspect, the invention relates to a process for preparing a carbon-deposited alkali metal oxyanion electrode material, comprising a dry high-energy milling step of precursors, where the precursors comprise a metal source. Optionally, the process comprises reduction of the oxidation state of at least one metal ion of the metal source in a thermal treatment without full reduction to an elemental state. The reaction is completed in order to obtain the carbon-deposited alkali metal oxyanion electrode material.

In a further aspect, the invention relates to a process for preparing a carbon-deposited alkali metal oxyanion electrode material, comprising a dry milling step of precursors at an energy sufficient to obtain strong agglomerates of the precursors, where the precursors comprise an Fe(II) source. The precursors are then thermally treated in order to obtain the carbon-deposited alkali metal oxyanion electrode material.

In a further aspect, the invention relates to a process for preparing a carbon-deposited alkali metal oxyanion electrode material, comprising a dry milling step of precursors at an energy sufficient to obtain strong agglomerates of the precursors, where the precursors comprise an Fe(III) source. The Fe(III) is then reduced to Fe(II) in a thermal treatment without full reduction to an elemental state. The reaction is completed in order to obtain the carbon-deposited alkali metal oxyanion electrode material.

In a yet further aspect, the invention relates to a process for preparing a carbon-deposited alkali metal oxyanion electrode material, comprising a dry milling step of precursors at an energy sufficient to obtain strong agglomerates of the precursors, where the precursors comprise a metal source and a reducing agent source. The oxidation state of at least one metal ion of the metal source is then reduced in a thermal treatment without full reduction to an elemental state. The reaction is completed in order to obtain the carbon-deposited alkali metal oxyanion electrode material.

In yet another aspect, the invention relates to a process for preparing a carbon-deposited alkali metal oxyanion electrode material, comprising a dry milling step of precursors at an energy sufficient to obtain strong agglomerates of the precursors, where the precursors comprise an Fe(III) source and a reducing agent source. The Fe(III) is then reduced to Fe(II) in a thermal treatment without full reduction to an elemental state. The reaction is completed in order to obtain the carbon-deposited alkali metal oxyanion electrode material.

In another aspect, the invention relates to a process for preparing a carbon-deposited alkali metal oxyanion electrode material, comprising a dry milling step of precursors at an energy sufficient to obtain strong agglomerates of the precursors, where the precursors comprise a metal source. The oxidation state of at least one metal ion of the metal source is then reduced in a thermal treatment in the presence of a reducing agent without full reduction to an elemental state. The reaction is completed in order to obtain the carbon-deposited alkali metal oxyanion electrode material.

In another aspect, the invention relates to a process for preparing a carbon-deposited alkali metal oxyanion electrode material, comprising a dry high-energy milling step of precursors, where the precursors comprise an Fe(III) source. The Fe(III) is then reduced to Fe(II) in a thermal treatment in the presence of a reducing agent without full reduction to an elemental state. The reaction is completed in order to obtain the carbon-deposited alkali metal oxyanion electrode material.

In one non-limiting embodiment, the herein described metal source comprises a mixture of metals having the same or difference valence state.

In one non-limiting embodiment, the herein described metal source comprises a mixture of Fe source and Mn source. For example, a mixture of Fe(III) and Mn(III), a mixture of Fe(III) and Fe(II), a mixture of Fe(III) and Mn(II), a mixture of Fe(II) and Mn(III), or any combinations thereof.

In yet another aspect, the invention relates to a process for preparing a carbon-deposited alkali metal oxyanion electrode material, comprising a dry milling step of precursors at an energy sufficient to obtain strong agglomerates of the precursors, where the precursors comprise a metal source. The precursors are then thermally treated in order to obtain the carbon-deposited alkali metal oxyanion electrode material.

In one non-limiting embodiment, the herein described dry milling step of precursors at an energy sufficient to obtain strong agglomerates of the precursors is conducted under air.

In one non-limiting embodiment, the dry milling step of precursors at an energy sufficient to obtain strong agglomerates of the precursors and/or heating steps are conducted under non-oxidizing or inert gas such as, but without being limited thereto, N₂, argon or vacuum. A reducing atmosphere, which participates in the reduction or prevents the oxidation of the oxidation state of at least one metal in the precursors without full reduction to an elemental state, is not required, although it may be used if desired.

In one non-limiting embodiment, the herein described organic source is, but without being limited thereto, a solid, semi-solid, liquid or waxy hydrocarbon including its derivatives (such as hydrocarbon having any functional group attached thereto or comprising heteroatoms), or a solid, semi-solid, liquid or waxy carbonaceous product,

In one non-limiting embodiment, the herein described reducing agent source is, but without being limited thereto, a solid, semi-solid, liquid or waxy hydrocarbon including its derivatives (such as hydrocarbon having any functional group attached thereto or comprising heteroatoms), or a solid, semi-solid, liquid or waxy carbonaceous product, which participates or produces a compound which participates in the reduction or prevents the oxidation of the oxidation state of at least one metal in the precursors without full reduction to an elemental state.

In one non-limiting embodiment, the herein described reducing agent is, but without being limited thereto, a reducing atmosphere which participates in the reduction or prevents the oxidation of the oxidation state of at least one metal in the precursors without full reduction to an elemental state.

In one non-limiting embodiment, the herein described reducing atmosphere is, but without being limited thereto, an externally applied reducing atmosphere, a reducing atmosphere derived from the degradation of a compound, or a reducing atmosphere derived from the reduction reaction.

In one non-limiting embodiment, the above externally applied reducing atmosphere comprises a gas such as, but without being limited thereto, CO, H₂, NH₃ or HC, which participates in the reduction or prevents the oxidation of the oxidation state of at least one metal in the precursors without full reduction to an elemental state. HC refers to any hydrocarbon and its derivatives (such as a hydrocarbon having any functional group attached thereto or comprising heteroatoms), or carbonaceous product in gas or vapor form. The externally applied reducing atmosphere can also comprise an inert gas such as, but without being limited thereto, CO₂, N₂, argon and other inert gases.

In one non-limiting embodiment, the above reducing atmosphere derived from the degradation of a compound is, but without being limited thereto, a reducing atmosphere which is produced when the compound is degraded or is transformed during the heating step. In one non-limiting embodiment, this compound is a reducing agent source which is degraded or is transformed during the heating step and produces a reducing atmosphere which participates in the reduction or prevents the oxidation of the oxidation state of at least one metal in the precursors without full reduction to an elemental state. In one non-limiting embodiment, this reducing atmosphere comprises CO, CO/CO₂ or H₂.

In one non-limiting embodiment, the above reducing atmosphere derived from the reduction reaction is, but without being limited thereto, a reducing atmosphere that is produced during the heating step, and which participates in the reduction or prevents the oxidation of the oxidation state of at least one metal in the precursors without full reduction to an elemental state. In one non-limiting embodiment, this reducing atmosphere comprises CO, CO/CO₂ or H₂.

The herein described dry milling step of precursors produces strong agglomerates of the milled compounds. In contrast, other milling techniques produce compounds which are not so agglomerated and are easily dispersible. The agglomerates obtained by the process according to the invention are referred to as “strong” agglomerates.

In one non-limiting embodiment, the herein described process produces a carbon-deposited alkali metal oxyanion electrode material in the form of strong agglomerates. Strong agglomerates are agglomerates in which the particles are held together by strong cohesive forces. The strong agglomerates are further reduced in size, to break them up in smaller particles, such as in powder form to obtain an electrode material suitable for battery applications.

In one non-limiting embodiment, the carbon-deposited alkali metal oxyanion electrode material in the form of strong agglomerates is reduced to powder using any known dry or wet milling technique, such as but without being limited to, colloid mills (e.g. ball mills, bead mills), disc mills, planetary ball mills, stirred ball mills, mixer mills, vibration mills, rotor-stator mixers, high-pressure homogenizers, sand mills, pebble mills, jar mills, ultrasonic and ultrasonic assisted milling, and equivalent milling equipments; the person skill in the art is able to identify suitable equipments without undue experimentation and without departing from the present invention.

In one further non-limiting embodiment, the carbon-deposited alkali metal oxyanion electrode material in the form of strong agglomerates is reduced to powder under an inert atmosphere, preferably dry, and/or with a dry liquid media.

In one further non-limiting embodiment, the carbon-deposited alkali metal oxyanion electrode material in the form of strong agglomerates is reduced to powder by jet milling performed under an inert atmosphere, such as dry nitrogen.

In one non-limiting embodiment, the carbon-deposited alkali metal oxyanion electrode material is composed, after powderization, of particles with a D₉₀≦30 μm.

In another aspect, the invention relates to a mixture of carbon-deposited alkali metal oxyanion electrode material precursors in the form of strong agglomerates.

Strong agglomerates are known structures in the art of ceramics and have been described e.g. in Tomasi et al., Cerâmica vol. 44 n. 289 São Paulo September/October 1998, the content of which is hereby incorporated by reference and which shows the effect of high-energy milling on the agglomeration state of powders. Strength of agglomerates may be characterized by methods such as compaction, or ultrasonic dispersion. Characterization of yttrria powders agglomerates strength by ultrasonic dispersion has been described e.g. in Am. Cer. Soc. Bull., 65, 1591, 1986, for example in FIG. 2 therein, which is included hereinafter:

In another aspect, the invention relates to a carbon-deposited alkali metal oxyanion electrode material in the form of strong agglomerates which is obtained after treatment under heat of the herein described alkali metal oxyanion electrode material precursors in the form of strong agglomerates.

In one non-limiting embodiment, the alkali metal oxyanion electrode material precursors in the form of strong agglomerates are composed of particles with a D₉₀≧50 μm, preferably a D₉₀≧100 μm, even more preferably a D₉₀≧150 μm.

In one non-limiting embodiment, the alkali metal oxyanion electrode material precursors in the form of strong agglomerates are composed of particles with a D₉₇≧50 μm, preferably a D₉₇≧100 μm, even more preferably a D₉₇≧150 μm.

In one non-limiting embodiment, the carbon-deposited alkali metal oxyanion electrode material in the form of strong agglomerates requires a further milling step thereof before being suitable for battery applications and is composed of particles with a D₉₀≧50 μm, preferably a D₉₀≧100 μm, even more preferably a D₉₀≧150 μm.

In one non-limiting embodiment, the carbon-deposited alkali metal oxyanion electrode material in the form of strong agglomerates requires a further milling step thereof before being suitable for battery applications and is composed of particles with a D₉₇≧50 μm, preferably a D₉₇≧100 μm, even more preferably a D₉₇≧150 μm.

In another aspect, the invention relates to a battery comprising an electrode comprising the herein described carbon-deposited alkali metal oxyanion electrode material and having improved electrochemical performances.

In one non-limiting embodiment, the improved electrochemical performances relate to mean electrochemical capacity.

In one non-limiting embodiment, the improved electrochemical performances relate to the shape of the voltage discharge curve or power capability as expressed in a ragone plot.

In one non-limiting embodiment, the improved electrochemical performances relate to the specific electrochemical capacity (mAh/g).

In one non-limiting embodiment, the improved electrochemical performances relate to the specific surface area (BET in m²/g) and optionally, to the carbon content.

In one non-limiting embodiment, the thermal step or heating step includes a temperature selected within the range of: about 300° C. to about 950° C., about 350° C. to about 950° C., about 400° C. to about 950° C., about 450° C. to about 950° C., about 500° C. to about 950° C., about 550° C. to about 950° C., about 600° C. to about 950° C., about 650° C. to about 950° C., about 700° C. to about 950° C., about 750° C. to about 950° C., about 800° C. to about 950° C., about 850° C. to about 950° C., or about 900° C. to about 950° C. The person skilled in the art will be able to select any alternative suitable temperature or any temperature falling within any of the ranges above without departing from the spirit of the invention.

In one non-limiting embodiment, the precursors include an Fe(III) source and the thermal step or heating step includes a reducing step which is performed at a temperature selected within the range of: about 300° C. to about 700° C., about 350° C. to about 700° C., about 360° C. to about 700° C., about 370° C. to about 700° C., about 380° C. to about 700° C., about 390° C. to about 700° C., and about 400° C. to about 700° C. Preferably, the temperature is selected within the range of about 350° C. to about 450° C., more preferably within the range of about 380° C. to about 450° C., even more preferably the thermal step or heating step includes a reducing step which is performed at a temperature of about 380° C. in the presence of a reducing agent source. The person skilled in the art will be able to select any alternative suitable temperature or any temperature falling within any of the ranges above without departing from the spirit of the invention.

In one non-limiting embodiment, the precursors include an Fe(II) source and the thermal step or heating step includes a temperature selected within the range of: about 300° C. to about 700° C., about 350° C. to about 700° C., about 360° C. to about 700° C., about 370° C. to about 700° C., about 380° C. to about 700° C., about 390° C. to about 700° C., and about 400° C. to about 700° C. Preferably, the temperature is selected within the range of about 350° C. to about 450° C., more preferably within the range of about 380° C. to about 450° C. The person skilled in the art will be able to select any alternative suitable temperature or any temperature falling within any of the ranges above without departing from the spirit of the invention.

In one non-limiting embodiment, the precursors include an Fe(II) source and the thermal step or heating step includes a temperature selected within the range of: about 450° C. to about 600° C., about 480° C. to about 600° C., and about 500° C. to about 600° C., preferably the thermal step or heating step includes a temperature at 500° C. The person skilled in the art will be able to select any alternative suitable temperature or any temperature falling within any of the ranges above without departing from the spirit of the invention.

In one non-limiting embodiment, the process of the invention includes a subsequent flash thermal treatment on the oxyanion end-product in order to improve the graphitization of carbon deposit while avoiding partial decomposition of the oxyanion. The flash thermal treatment can be operated at a temperature selected from the following temperature ranges of between about 650° C. and about 900° C., about 700° C. and about 900° C., about 750° C. and about 900° C., about 800° C. and about 900° C., or about 825° C. and about 900° C., or about 850° C. and about 900° C. The person skilled in the art will be able to select any alternative suitable temperature or any temperature falling within any of the ranges above without departing from the spirit of the invention.

The flash thermal treatment can be operated during a period of time selected from the following time ranges of between about 10 seconds and about ten minutes, about 30 seconds and about ten minutes, about one minute and about ten minutes, about two minutes and about ten minutes, about three minutes and about ten minutes, about four minutes and about ten minutes, or about five minutes and about ten minutes. The person skilled in the art will be able to select any alternative suitable time period or any time period falling within any of the ranges above without departing from the spirit of the invention.

In one non-limiting embodiment, the herein described dry milling step is performed during a time period selected from the following time ranges of between about 5 minutes to about 4 hours, about 10 minutes to about 4 hours, about 30 minutes to about 4 hours, about 60 minutes to about 4 hours, about 90 minutes to about 4 hours, about 120 minutes to about 4 hours, about 150 minutes to about 4 hours, about 180 minutes to about 4 hours, about 210 minutes to about 4 hours, or about 230 minutes to about 4 hours. The person skilled in the art will be able to select any alternative suitable time period or any time period falling within any of the ranges above without departing from the spirit of the invention.

In one non-limiting embodiment, the herein described thermal step or heating step is held for a time selected within the range of: about 30 minutes to about 4 hours, about 60 minutes to about 4 hours, about 90 minutes to about 4 hours, about 120 minutes to about 4 hours, about 150 minutes to about 4 hours, about 180 minutes to about 4 hours, about 210 minutes to about 4 hours, or about 230 minutes to about 4 hours. The person skilled in the art will be able to select any alternative suitable time period or any time period falling within any of the ranges above without departing from the spirit of the invention.

It is noted that the temperature at which the thermal step or heating step for any given precursors is performed can be selected without undue effort by the person skilled in the art and without departing from the present invention.

These and other aspects and features of the present invention will now become apparent to those of ordinary skill in the art upon review of the following description of specific embodiments of the invention in conjunction with the accompanying drawings.

### BRIEF DESCRIPTION OF THE FIGURES

A detailed description of examples of implementation of the present invention is provided hereafter with reference to the following figures, in which:

FIG. 1 represents the particle size distribution of FePO₄.2H₂O precursor (Curve A), agglomerates of precursors (FePO₄.2H₂O/Li₂CO₃/polyethylene beads/stearic acid) obtained after milling in Union Process 1-S Attritor® (Curve B), as prepared in example 1, and of as-synthesized C—LiFePO₄ agglomerates (Curve C), as prepared in example 1. The material (LMP-1) has a specific BET of 8.6 m²/g, a carbon content of 2.23 wt. %, a tapped density of 1.4 g/cm³ and a press density of 2.3 g/cm³.

FIG. 2 represents the SEM microscopy observation of as-synthesized C—LiFePO₄ of FIG. 1, as prepared in example 1, in the form of large strong agglomerates of submicron lithium iron phosphate having a carbon deposit.

FIG. 3 represents the BET of as-synthesized C—LiFePO₄ agglomerates, as prepared in example 3, with milling step of precursors (FePO₄.2H₂O/Li₂CO₃/polyethylene beads/stearic acid) in Union Process 1-S Attritor® performed for different weight of beads to powder being grinded ratio (B/P), milling time and rotating speed of agitating arms (rpm). BET (in m²/g) is indicated on Y axis and milling time (minutes) is indicated on X axis. B/P ratio and rotating speed of agitating arms (rpm) are indicated in legend.

FIG. 4 represents the particle size distribution of as-synthesized C—LiFePO₄ agglomerates (Curve A) as prepared in example 1 (LMP-2), and of as-synthesized C—LiFePO₄ agglomerates after ball milling in N-methyl-pyrrolidone with zirconia media for 10 hours (Curve B), as prepared in example 5.

FIG. 5 represents cathode capacity, determined at room temperature and C/12, C and 10 C discharge rate, for two A and B Li/1M LiPF₆ EC:DEC 3:7/C—LiFePO₄ batteries, as prepared in example 5. Battery voltage (in Volt vs Li⁺/Li) is indicated on Y axis and capacity (in mAh/g) is indicated on X axis. Battery A has been prepared with a positive electrode containing C—LiFePO₄ according to the present invention (LMP-1 as prepared in example 1), battery B with a commercial C—LiFePO₄ (Phostech Lithium Life Power® grade P1).

FIG. 6 represents cathode capacity, determined at room temperature and C/12 discharge rate, for a Li/1M LiPF₆ EC:DEC 3:7/C—LiFe_{0.5}Mn_{0.5}PO₄ battery, as prepared in example 5. Battery voltage (in Volt vs Li⁺/Li) is indicated on Y axis and capacity (in mAh/g) is indicated on X axis. Battery has been prepared with a positive electrode containing C—LiFe_{0.5}Mn_{0.5}PO₄ according to the present invention (LMP-3 as prepared in example 2).

FIG. 7 represents battery power capability (ragone plot), determined at room temperature, for two A and B Li/1M LiPF₆ EC:DEC 3:7/C—LiFePO₄ batteries, as prepared in example 5. Capacity (in mAh/g) is indicated on Y axis and discharge rate (C-rate; a 1 C rate corresponding to discharge of full capacity in 1 hour) is indicated on X axis, initial capacity is determined by slow-scan voltammetry. Battery A has been prepared with a positive electrode containing C—LiFePO₄ according to the present invention (LMP-1 as prepared in example 1), battery B with a commercial C—LiFePO₄ (Phostech Lithium Life Power® grade P1).

FIG. 8 illustrates cycling capability, determined at 60° C. and C/4 discharge rate, for two A and B Li/1M LiPF₆ EC:DEC 3:7/C—LiFePO₄ batteries, as prepared in example 5. Battery capacity (in mAh/g) is indicated on Y axis and cycle number is indicated on X axis, initial capacity is determined by slow-scan voltammetry. Battery A has been prepared with a positive electrode containing C—LiFePO₄ according to the present invention (LMP-1 as prepared in example 1), battery B with a commercial C—LiFePO₄ (Phostech Lithium Life Power® grade P1).

FIG. 9 represents the particle size distribution of agglomerates of precursors (FePO₄.2H₂O/Li₂CO₃/polyethylene beads/stearic acid) obtained after milling in Union Process 30SD Attritor®, as prepared in example 1.

FIG. 10 represents the particle size distribution of agglomerates of precursors (FePO₄.2H₂O/Li₂CO₃/polyethylene beads/stearic acid) obtained after milling in Union Process 30SD Attritor®, as prepared in example 1, and after a 30 s ultrasonic treatment.

FIG. 11 represents the particle size distribution of as-synthesized C—LiFePO_{4 (LMP-}2) agglomerates obtained after milling in Union Process 30SD Attritor® and subsequent heating step, as prepared in example 1.

FIG. 12 represents the particle size distribution of as-synthesized C—LiFePO₄ agglomerates (LMP-2), as prepared in example 1, and after a 30 s ultrasonic treatment.

FIG. 13 represents the particle size distribution of as-synthesized C—LiFePO₄ (Life Power® P1 grade) after a 30 s ultrasonic treatment. Prior to the ultrasonic treatment the C—LiFePO₄ P1 grade, isolated just after the thermal treatment step in a rotary kiln, is in the form of beads having a 5 mm mean particle size as observed by scanning electron microscopy.

FIG. 14 represents the particle size distribution of as-synthesized carbon-deposited lithium iron zirconium phosphosilicate, obtained from iron oxalate, Li₂CO₃, LiH₂PO₄, Si(OC₂H₅)₄, Zr(IV) acetate hydroxide, at an atomic ratio Li:Fe:Zr:P:Si=1:0.95:0.05:0.95:0.05, as prepared in example 7.

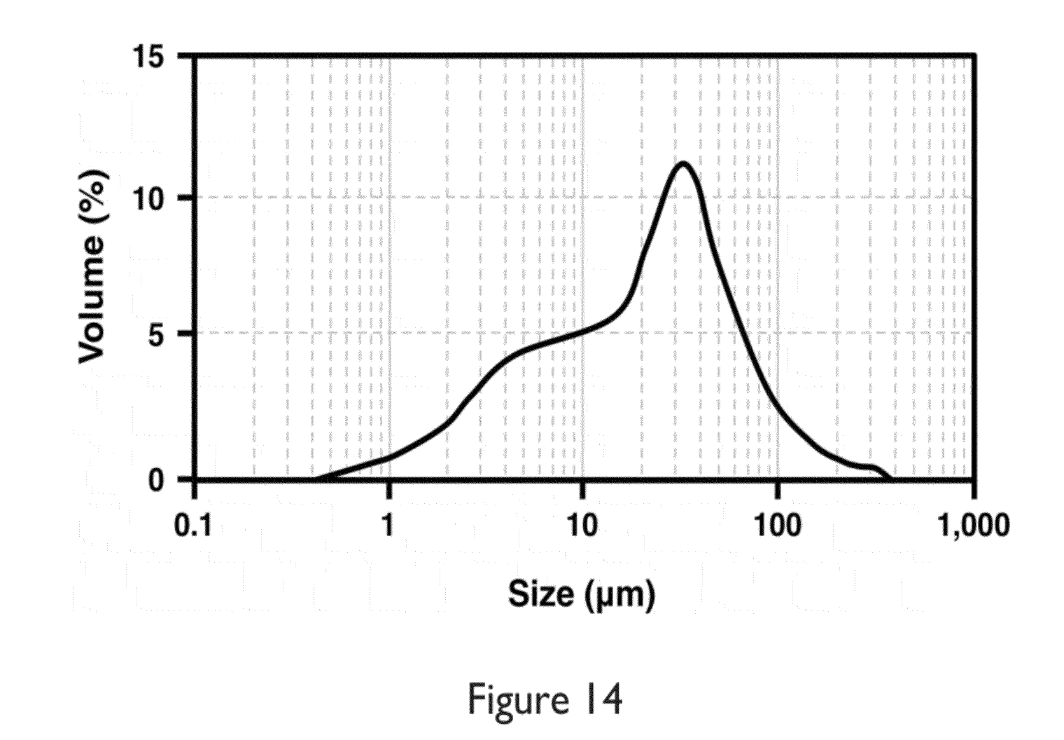

### DESCRIPTION OF ILLUSTRATIVE EMBODIMENTS

In one broad aspect, the invention relates to a carbon-deposited alkali metal oxyanion electrode material and to a process for preparing same.

In a non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 20% as atoms of Na and/or K, and 0<a≦8;
M comprise at least 50% at. of Fe(II), or Mn(II), or a mixture thereof, and 1≦m≦3; and
XO₄ represents PO₄, alone or partially replaced by at most 30 mol % of SO₄ or SiO₄, and 0<x≦3; and
   wherein M, X, a, m and x are selected as to maintain electroneutrality of said compound.

In another non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 10% as atoms of Na or K, and 0<a≦8;
M is selected from the group consisting of Fe(II), Mn(II), and mixture thereof, alone or partially replaced by at most 50% as atoms of one or more other metals selected from Ni and Co, and/or by at most 20% as atoms of one or more aliovalent or isovalent metals other than Ni or Co, and/or by at most 5% as atoms of Fe(III), and 1≦m≦3; and
XO₄ represents PO₄, alone or partially replaced by at most 10 mol % of at least one group chosen from SO₄ and SiO₄, and 0<x≦3; and
   wherein M, X, a, m and x are selected as to maintain electroneutrality of said compound.

In yet another non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 10% as atoms of Na or K, and 0<a≦8;
M is selected from the group consisting of Fe(II), Mn(II), and mixture thereof, alone or partially replaced by at most 50% as atoms of one or more other metals chosen from Ni and Co, and/or by at most 15% as atoms of one or more aliovalent or isovalent metals selected from the group consisting of Mg, Mo, Nb, Ti, Al, Ta, Ge, La, Y, Yb, Cu, Sm, Sn, Pb, Ag, V, Ce, Hf, Cr, Zr, Bi, Zn, Ca, B and W, and/or by at most 5% as atoms of Fe(III); and 1≦m≦3; and
XO₄ represents PO₄, alone or partially replaced by at most 10 mol % of SO₄ or SiO₄, and 0<x≦3; and
   wherein M, X, a, m and x are selected as to maintain electroneutrality of said compound.

In yet a further non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 10% as atoms of Na or K, and 0<a≦≦8;
M is selected from the group consisting of Fe(II), Mn(II), and mixture thereof, alone or partially replaced by at most 10% as atoms of one or more other metals chosen from Ni and Co, and/or by at most 10% as atoms of one or more aliovalent or isovalent metals selected from the group consisting of Mg, Mo, Nb, Ti, Al, Ta, Ge, La, Y, Yb, Cu, Sm, Sn, Pb, Ag, V, Ce, Hf, Cr, Zr, Bi, Zn, Ca, B and W, and/or by at most 5% as atoms of Fe(III); and 1≦m≦3; and
XO₄ represents PO₄, alone or partially replaced by at most 10 mol % of at least one group chosen from SO₄ and SiO₄, and 0<x≦3; and
   wherein M, X, a, m and x are selected as to maintain electroneutrality of said compound.

In another yet non-limiting embodiment, the carbon-deposited alkali metal oxyanion of the present invention comprises particles of a compound corresponding to the general nominal formula LiMPO₄ which has an olivine structure, and which carry, on at least a portion of their surface, a film of carbon deposited by pyrolysis, M comprising at least 50% at., preferably at least 80% at., more preferably at least 90% at. of Fe(II), or Mn(II), or a mixture thereof.

In another yet further non-limiting embodiment, the carbon-deposited alkali metal oxyanion of the present invention comprises particles of a compound corresponding to the general nominal formula LiMPO₄ which has an olivine structure, and which carry, on at least a portion of their surface, a film of carbon deposited by pyrolysis, M comprising at least 65% at. of Mn(II) and at least 25% at. of Fe(II).

In another yet further non-limiting embodiment, the carbon-deposited alkali metal oxyanion of the present invention comprises particles of a compound corresponding to the general nominal formula LiFePO₄ which has an olivine structure and which carry, on at least a portion of their surface, a film of carbon deposited by pyrolysis.

In another non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 20% as atoms of Na and/or K, and 0<a≦8;
M comprise at least 80% at. of Fe(II), or Mn(II), or a mixture thereof, and 1≦m≦3; and
XO₄ represents a phosphosilicate ([SiO₄]ᵥ[PO₄]_{w}), and 0.02≦v/(v+w)≦0.2; and
   wherein M, X, a, m and x are selected as to maintain electroneutrality of said compound.

In a non-limiting embodiment, the carbon-deposited alkali metal oxyanion of the present invention comprises particles of a compound corresponding to the general nominal formula alkali metal:M:M′:P:Si having ratios of about 1:0.7 to 1:>0 to 0.3:>0.7 to 1:>0 to 0.3, where “>0” does not include 0, which has an olivine structure, and which carry, on at least a portion of their surface, a film of carbon deposited by pyrolysis, where M and M′ may be the same or different metal.

In another non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 20% as atoms of Na and/or K, and 0<a≦8;
M comprise at least 90% at. of Fe(II), or Mn(II), or a mixture thereof, and 1≦m≦3; and
M further comprise at least one +3 or +4 valency metal; and
XO₄ represents a phosphosilicate ([SiO₄]ᵥ[PO₄]_{w}), and 0.02≦v/(v+w)≦0.2; and
   wherein M, X, a, m and x are selected as to maintain electroneutrality of said compound.

In another non-limiting embodiment, the carbon-deposited alkali metal oxyanion of the present invention comprises particles of a compound corresponding to the general nominal formula AₐMₘ(XO₄)ₓ which has an olivine structure, and which carry, on at least a portion of their surface, a film of carbon deposited by pyrolysis, the formula AₐMₘ(XO₄)ₓ being such that:
A represents Li, alone or partially replaced by at most 20% as atoms of Na and/or K, and 0<a≦8;
M comprise at least 90% at. of Fe(II), or Mn(II), or a mixture thereof, and 1≦m≦3; and
M further comprise at least one +4 valency metal; and
XO₄ represents a phosphosilicate ([SiO₄]ᵥ[PO₄]_{w}), and 0.02≦v/(v+w)≦0.2; and
   wherein M, X, a, m and x are selected as to maintain electroneutrality of said compound.

In one non-limiting embodiment, the 4+ valency metal comprises at least one of Zr⁴⁺, Ti⁴⁺, Nb⁴⁺, Mo⁴⁺, Ge⁴⁺, Ce⁴⁺or Sn⁴⁺. In one non-limiting embodiment, the 3+ valency metal comprises at least one of Al³⁺, Y³⁺, Nb³⁺, Ti³⁺, Ga³⁺, Cr³⁺or V³⁺.

In another non-limiting embodiment, the present invention relates to an optimized carbon-deposited alkali metal phosphosilicate cathode material, comprising particles which carry, on at least a portion of their surface, carbon deposited by pyrolysis, where the particles have a general element ratios Li:Fe:Zr:PO₄:SiO₄, at about 1+/−x:0.95+/−x:0.05+/−x:0.95+/−x:0.05+/−x ratios, where x is independently about 20% of value.

In another non-limiting embodiment, the present invention relates to an optimized carbon-deposited alkali metal phosphosilicate cathode material, comprising particles which carry, on at least a portion of their surface, carbon deposited by pyrolysis, where the particles have a general element ratios Li:Fe:Zr:PO₄:SiO₄, at about 1+/−x:0.95+/−x:0.05+/−x:0.95+/−x:0.05+/−x ratios, where x is independently about 10% of value.

In one non-limiting embodiment, x is about 5% of value.

In another non-limiting embodiment, x is about 4% of value.

In yet another non-limiting embodiment, x is about 3% of value.

In yet another non-limiting embodiment, x is about 2% of value.

In yet another non-limiting embodiment, the present invention relates to a carbon-deposited alkali metal phosphosilicate cathode material, comprising particles which carry, on at least a portion of their surface, carbon deposited by pyrolysis, where the particles have the general formula LiM₁₋ₓM^{I}ₓ(PO₄)₁₋₂ₓ(SiO₄)₂ₓ where M is Fe and/or Mn, and M^{I} is 4+ metal. Optionally, the phosphate polyanion (PO₄) can also be partly substituted by sulfate polyanion (SO₄) and/or the lithium metal can be partly substituted by Na and/or K.

By “general nominal formula” one means that the stoichiometry of the material of the invention can vary by a few percents from stoichiometry due to substitution or other defects present in the structure, including anti-sites structural defects such as, without any limitation, cation disorder between iron and lithium in LiFePO₄ crystal, see for example Maier et al. [Defect Chemistry of LiFePO₄, Journal of the Electrochemical Society, 155, 4, A339-A344, 2008] and Nazar et al. [Proof of Supervalent Doping in Olivine LiFePO₄, Chemistry of Materials, 2008, 20 (20), 6313-6315].

In a non-limiting embodiment, the carbon deposit is in the form of an adherent and non-powdery carbon deposit and is present as a more or less uniform deposit. The carbon deposit is present on at least part of the surface of the alkali metal oxyanion and precursors thereof. In one non-limiting embodiment, the carbon deposit represents up to 15% by weight, preferably from 0.5 to 5% by weight, most preferably from 1 to 3% by weight, with respect to the total weight of the material. Deposition of carbon by pyrolysis of an organic carbon precursor can be performed on complex metal oxyanion, in particular AₐMₘ(XO₄)ₓ or its precursors as described, for instance, in WO 02/027824, WO 02/027823, CA 2,307,119, US 2011/210293, US 2002/195591 and US 2004/157126.

In one non-limiting embodiment, the carbon deposit is a deposit which is more or less completely encloses the material.

In one non-limiting embodiment, the strong agglomerates of the present invention have a D₉₀ size which is between about 50 μm and about 500 μm, preferably between about 100 μm and about 300 μm, more preferably between about 100 μm and about 200 μm.

In one further non-limiting embodiment, the strong agglomerates of the present invention have a D₉₇ size which is between about 50 μm and about 500 μm, preferably between about 100 μm and about 300 μm, more preferably between about 100 μm and about 200 μm.

In one further non-limiting embodiment, the carbon-deposited alkali metal oxyanion of the invention is in the form of strong agglomerates of submicron particles which have a size of between about 10 nm and about 500 nm, preferably between about 50 nm and about 300 nm, more preferably between about 100 nm and about 200 nm.

In one further non-limiting embodiment, the carbon-deposited alkali metal oxyanion of the invention is in the form of strong agglomerates of submicron particles which have a D₅₀ size which is between about 10 nm and about 500 nm, preferably between about 50 nm and about 300 nm, more preferably between about 100 nm and about 200 nm.

The expression strong agglomerates can be used in this specification to describe the structure of the precursor or the structure of the carbon-deposited alkali metal oxyanion.

In one non-limiting embodiment, when we refer herein to the cathode material being used as cathode in a lithium battery, the lithium battery can be, for example but without being limited thereto, a solid electrolyte battery in which the electrolyte can be a plasticized or non-plasticized polymer electrolyte, a battery in which a liquid electrolyte is supported by a porous separator, or a battery in which the electrolyte is a gel.

In a broad non-limiting implementation, the process of the invention is performed in a chemical reactor allowing controlling the atmosphere and/or of the heat treatment temperature.

In a non-limiting implementation, performed at a laboratory scale, the process of the invention is conveniently operated in a tubular furnace or an airtight metallic container placed into a furnace, both with a gas inlet and outlet allowing control of the atmosphere in contact with the strong agglomerates of the alkali metal oxyanion of the invention and/or of its precursors.

In a non-limiting implementation, performed at an industrial scale, the process of the invention is preferably carried out continuously, preferably in a reactor that promotes the equilibrium of the hard or dense agglomerates of the invention, with the gaseous phase, e.g. from among those reactors, rotary kilns, push kilns, fluidized beds, belt-driven kilns, that allow control of the composition and the circulation of the gaseous atmosphere. Utilization of large batch kiln, such as baking kiln, is not excluded. The person skilled in the art will be able to identify suitable alternative reactors without undue effort and without departing from the present invention.

In a broad non-limiting implementation, the duration time of the heating step of the invention is chosen as a function of the nature of the precursors and other parameters, such as reasonable time-constraints. The person skilled in the art will be able to identify suitable alternative heating step duration time without undue effort and without departing from the present invention.

In one non-limiting embodiment, the process of the invention for preparing an electrode material having a carbon deposit and of general nominal formula AₐMₘ(XO₄)ₓ is carried out by reacting, by placing under thermodynamic or kinetic equilibrium, a gas atmosphere with strong agglomerates precursors of the invention in the required proportions of the following source compounds a), b), c), d) and e):

a) a compound or several compounds sources of the element or elements forming A;
b) a compound or several compounds sources of the element or elements forming M;
c) a compound or several compounds sources of the element or elements forming X;
d) a compound or several compounds sources of oxygen;
e) a compound or several compounds sources of carbon deposit;

the synthesis being carried out continuously in a furnace while controlling the composition of said gas atmosphere, the temperature of the synthesis reaction and the level of the source compound c) relative to the other source compounds a), b), d) and e), in order to fix the oxidation state of a transition metal in M at the degree of valency desired for the structure of the compound of type AₐMₘ(XO₄)ₓ, the process comprising a stage of pyrolysis of the compound or several compounds in e). For the preparation of this material, the compound or several compounds in a) comprise a lithium-containing compound chosen, for example, from the group consisting of lithium oxide, lithium hydroxide, lithium carbonate, the neutral phosphate Li₃PO₄, LiPO₃, the hydrogen phosphate LiH₂PO₄, lithium ortho-, meta- or polysilicates, lithium sulfate, lithium oxalate, lithium acetate and one of their mixtures. The compound or several compounds in b) comprise an iron-containing and/or manganese-containing compound, for example iron(III) oxide or magnetite, trivalent iron phosphate, Fe₂P₂O₇, Mn₂P₂O₇, (Fe,Mn)P₂O₇, lithium iron hydroxyphosphate, FeCl₂, FeCl₃, FeOOH, or trivalent iron nitrate, FeCO₃, FeO, ferrous phosphate, hydrated or nonhydrated, vivianite Fe₃(PO₄)₂, Mn₃(PO₄)₂, (Fe,Mn)₃(PO₄)₂, iron acetate (CH₃COO)₂Fe, iron sulfate (FeSO₄), iron oxalate, ammonium iron phosphate (NH₄FePO₄), MnO, MnO₂, manganese acetate, manganese oxalate, manganese carbonate, manganese sulfate, manganese nitrate or one of their mixtures, or source of any metal-containing compound partially replacing Fe or Mn, such as without any limitation source of Ni, Co, Mg, Mo, Nb, Ti, Al, Ta, Ge, La, Y, Yb, Cu, Sm, Sn, Pb, Ag, V, Ce, Hf, Cr, Zr, Bi, Zn, Ca, B, or W in the form, without any limitation, of carbonate, sulfate, silicate, phosphate, halogenide, oxide, organo-metal, and one of their mixtures. The a) compound or several compounds in c) comprise phosphorus-containing compound, for example phosphoric acid and its esters, neutral phosphate Li₃PO₄, LiPO₃, hydrogen phosphate LiH₂PO₄, monoammonium or diammonium phosphates, trivalent iron phosphate, Fe₂P₂O₇, Mn₂P₂O₇, (Fe,Mn)P₂O₇, MnPO₄, MnHPO₄ or manganese ammonium phosphate (NH₄MnPO₄), or silicon-containing compound, for example tetraorthosilicate, nanosized SiO₂, Li₂SiO₃, Li₄SiO₄, tri-n-butoxy methyl silane, tributyl(butoxy) silane, hydroxy(trisec-butoxy)silane, pentyl(butoxy)silane, hexyl(butoxy)silane, decamethylpentacyclosiloxane, polydimethylsiloxane, polysiloxane, silane, organo-silane or a mixture thereof. The person skilled in the art will be able to select a suitable source compound e) without departing from the spirit of the invention.

All these compounds may additionally be a source of oxygen and some of them may be sources of at least two elements, such as from Li, Fe, Mn, P, Si and S. The deposition of carbon on the surface of the particles of complex oxide AₐMₘ(XO₄)ₓ is obtained by pyrolysis of a compound or several compounds in e).

In one non-limiting embodiment, the precursors further comprise f) at least one source compound of carbon. In one non-limiting embodiment, the source compound f) is present prior to the herein described first thermal step and/or prior to the herein described second thermal step.

In one non-limiting embodiment, the source compound a) is a lithium compound selected, for example, from the group consisting of lithium oxide, lithium hydroxide, lithium carbonate, Li₃PO₄, the hydrogen phosphate LiH₂PO₄, lithium ortho-, meta- or polysilicates, lithium sulfate, lithium oxalate, lithium acetate and one of their mixtures. The person skilled in the art will be able to select a suitable source compound a) without departing from the spirit of the invention.

In one non-limiting embodiment, the compound or several compounds source of iron comprise an Fe(III) source, for example M′PO₄ hydrated or not, where M′ comprises Fe(III), such as without being limited thereto, such as FePO₄ or FePO₄.2H₂O, optionally having a carbon deposit (for example C—FePO₄).

In one non-limiting embodiment, in the specific case of a source compound of valency 3+, the source compound may be selected from yttrium(III) 2-ethylhexanoate, yttrium(III) acetate, yttrium(III) acetylacetonate, yttrium(III) nitrate, aluminum acetate, aluminum isopropoxide, aluminum acetylacetonate, aluminum ethoxide, aluminum metaphosphate, aluminum monostearate, or a mixture thereof.

In one non-limiting embodiment, in the specific case of a source compound of valency 4+, the source compound may be selected from zirconium acetate hydroxide, zirconium alkoxide, zirconium(IV) acetylacetonate, zirconium(IV) ethoxide, zirconium(IV) hydrogenphosphate, zirconium(IV) silicate, titanium(IV) 2-ethylhexyloxide, titanium(IV) butoxide, germanium(IV) ethoxide, tin(IV) acetate, or a mixture thereof.

In one non-limiting embodiment, the compound or several compounds source of iron comprise an Fe(II) source, for example M″₂P₂O₇ or M″₃(PO₄)₂, where M″ comprises Fe(II), such as without being limited thereto, Fe₂P₂O₇ or Fe₃(PO₄)₂, optionally having a carbon deposit (for example C—Fe₂P₂O₇ or C—Fe₃(PO₄)₂).

In one non-limiting embodiment, the compound or several compounds source of lithium comprise Li₂CO₃.

In one non-limiting embodiment, the compound or several compounds source of iron comprise MPO₄ optionally hydrated where M comprises Fe(III), such as without being limited thereto, FePO₄.2H₂O and the compound or several compounds source of lithium comprise Li₂CO₃.

In one non-limiting embodiment, the compound or several compounds source of iron comprise M₂P₂O₇ or M₃(PO₄)₂, where M comprises Fe(II), such as without being limited thereto, Fe₂P₂O₇ or Fe₃(PO₄)₂, optionally having a carbon deposit, and the compound or several compounds source of lithium comprise Li₂CO₃.

The carbon deposit at the surface of the particles of alkali metal oxyanion AₐMₘ(XO₄)ₓ can be obtained by thermal decomposition of highly varied compound or several compounds in e).

In one non-limiting embodiment, the compound or several compounds in e) can be chosen, without any limitation, from liquid or solid and their derivatives (in particular polycyclic aromatic entities, such as tar or pitch), perylene and its derivatives, polyhydric compounds (for example, sugars and carbohydrates, and their derivatives), lactose, glycerol, fatty acids and their derivatives, polymers, copolymers, block copolymers, cellulose, starch and their esters and ethers, and their mixtures. Mention may be made, as examples of polymers, of polyolefins, polybutadienes, polyvinyl alcohol, polyvinyl butyral, condensation products of phenols (including those obtained from reaction with aldehydes), polymers derived from furfuryl alcohol, from styrene, from divinylbenzene, from naphthalene, from perylene, from acrylonitrile, from polyethylene, from polypropylene, and from vinyl acetate.

The person skilled in the art will be able to determine the ratios required for each of the source compound depending on the desired carbon-deposited alkali metal oxyanion product without departing from the spirit of the invention. For example, in the case of a carbon-deposited alkali metal phosphosilicate product, the source compounds are selected to provide a cathode material having alkali metal:M:M′:P:Si ratios of about 1:0.7 to 1:>0 to 0.3:>0.7 to 1:>0 to 0.3, where “>0” does not include 0, rather it means “more than 0”.

During the development of the process of the present invention, the inventors discovered that the mixing step of precursors may in some circumstances benefit the presence of a processing agent, for example as disclosed in example 1, where the mixing of FePO₄.2H₂O/Li₂CO₃/polyethylene beads led to sticking of precursors on the wall and beads of the attritor, which is undesirable. Replacing polyethylene beads, in whole or in part, with a processing agent, such as but without being limited thereto, stearic acid reduces the sticking phenomenon without the need to operate the process with more powerful equipment.

The effect of a processing agent could be described, without any limitation, as an anti-sticking agent.

In a non-limiting embodiment, the processing agent comprises carbon or is a source of carbon.

In another non-limiting embodiment, the processing agent comprises a surface active agent.

Numerous products commercially available can be used as surface active agent. In an industrial setting, it is beneficial to use low-cost and registered surface active agent. Most of these organic compounds are amphiphilic products containing an hydrophilic part which is ionic or non-ionic, and hydrophobic part allowing modification of particle surface tension. These products and mixtures thereof are often characterized by their HLB number corresponding to balance between hydrophobic and hydrophilic moieties. A large set of possible surfactant is provided for example in Stepan Global Product Catalog. Many others are available from worldwide specialty chemicals manufacturers.

The surface active agent may be selected for example from fatty acid (for example stearic acid), from fatty acid salts (for example lithium oleate), fatty acid esters, fatty alcohol esters, alkoxylated alcohols, alkoxylated amines, fatty alcohol sulfate or phosphate esters, imidazolium and quaternary ammonium salts, ethylene oxide/propylene oxide copolymer, ethylene oxide/butylene oxide copolymer and from reactive surfactants.

The person skilled in the art will understand that any of the herein described surface active agent may also be a source of carbon.

The fatty acid and fatty alcohol esters surfactants can be prepared through esterification. A convenient method to prepare fatty alcohol esters is also to initiate polymerization of at least one monomer from fatty alcohol salt, for example through reaction with ethylene oxide.

Numerous cost-effective combinations exist, allowing for fine-tuning of surface active agent properties. A major advantage of using fatty acid derivatives is that they can be used as a carbon source which provides a high quality carbon deposit generated upon pyrolysis of the fatty acid chains. Non-ionic fatty acids are mainly obtained by esterification of a fatty acid with glycol products (glycerol, glymes, etc.). The carbonization ratio depends on the fatty acid content, the surfactant and the fatty acid weight. To avoid low carbonization ratio and generation of a large amount of ashes during carbonization process, fatty acid with molecular weight >250 are preferred. Mention may be made of caprylate, undecylenate, palmitate, laurate, myristate, oleate, ricinoleate, linoleate, linolenate, and stearate. Oleate, stearate, linoleate, linolenate, and ricinoleate are preferred, more particularly oleate and stearate. If a high carbonization ratio is a concern, glycerol monooleate or monostearate are of particular interest. Optimization of surfactant formulation is also easily obtained by esterification of fatty acid with glymes to produce surfactants such as the following oleate derivatives C₁₇H₃₃—COO(CH₂CH₂O)₂OH or C₁₇H₃₃—COO(CH₂CH₂O)₉OOC—C₁₇H₃₃.

Length of the glyme part and choice of the fatty acid allow preparation of surfactant with suitable HLB value and desirable melting point, boiling point, melting point, wettability in view to obtain high quality carbon coating after pyrolysis. An important point to consider from an industrial perspective is that optimization of formulation is done at almost constant cost of an already cost-effective solution.

Some derivatives of fatty acid are also of particular interest. First of all, sugar-ester compounds composed of an hydrophilic sugar part, especially sucrose, sorbitol and sorbitan, an hydrophobic fatty acid part, and optionally a polyethylene oxide segment depending on the desired HLB value. For example, mention can be made of the Tween® surfactants produced by Uniquema, and especially Tween® 80 and 81 (polyoxyethylenesorbitan monooleate), or Tween® 85 (polyoxyethylenesorbitan trioleate). Polyoxyethylene sorbitol hexaoleates are also important surfactants.

Mention should be made also of montanic acids and its derivatives, especially as esters (Licowax® and Licolub® produced by Clariant) and of polar polyethylene wax such as Licowax® PED 191 (Clariant). More generally, Clariant offers a broad range of polymer additives, in various form (for example without any limitation, wax, powder, fine powder, micro powder, grain, fine grain, granule, flake, etc.), with potential use in the present invention, for example without any limitation, in the Licowax® (Licowax E, F, KLE, KPS, OP, PE 520, PE 190, PED 191, PED 192, PED 521, PED 522, C, R21, PE 130, PED 121, PED 153), Licolub® (Licolub WE 4, WE 40, WM 31, H 12, H 4, FA 1, CE 2 TP), Licocene® (Licocene PE 4201, PP 6102, PP 6502 TP, PP 7502 PP, PP 1302, PP 1502, PP 1602, PP 2602, PP 6102, PE MA 4221, PE MA 4351, PP MA 6252, PP MA 6252 TP, PP MA 6452 TP, PP MA 7452 TP), Licomont® (Licomont CaV 102, NaV 101, ET 141, BS100,), Ceridust® (Ceridust 8020 TP, 2051, 3141 TP, 3251, 3610, 3620, 3715, 3831, 3910, 3920 F, 3940 F, 3941 F, 6050 M), Tonerwax® (Tonerwax P 110, S 80) and Wax Emulsifier (2106, 4106) products families.

Tall oil obtained as a by-product of wood pulp manufacture is also an interesting source of fatty acid derivatives, especially grades obtained after fractional distillation tall oil rosin and by further distillation tall oil fatty acid which is a low cost, consisting mostly of oleic acid, source of fatty acids. Tall oil and tall oil fatty acid are available from numerous supplier (for example Arizona Chemical) such as in the form of an ester with glycerol or glymes. As carbonization ratio depends on molecular weight/boiling point of the fatty acid, it is also of particular interest to use fatty acid oligomers obtained from unsaturated fatty acid (oleate, linoleate, etc.). For example, mention can be made of the Unidyme® fatty acid oligomers available from Arizona Chemical. Dimerized product, especially dimerized oleic acid, used in the form of polyamide in ink the industry are also of interest and are produced for example by Henkel or Arizona Chemical.

In a specific and non-limiting example of implementation, a fatty acid salt of a transition metal cation is used as the surfactant and the organic carbon precursor. The carbon deposit generated by the pyrolysis reaction is in the form of carbon nanotubes. The transition metal cation acts as a catalyst for the nanotube formation. The transition metal is preferably selected from Ni, Co or Fe. The fatty acid contains preferably at least 6 carbon atoms, more preferably at least 10 and most preferably 14. The fatty acid is preferably selected from stearate, oleate, linoleate, linolenate, ricinolenate, preferably oleate and stearate. The use of nickel stearate as a precursor for carbon in the form of nanotubes precursor is described for example in J. Mater. Chem., 2005, 15, 844-849.

Alcoxylated alcohols may be selected from those which are obtained from ethylene oxide and/or propylene oxide. Most common alcohol precursors are fatty alcohols and alkyl-phenols (for example octyl or nonylphenol), especially the alkoxy alcohols available under the trade name Igepal®, from Rhodia Inc or Brij® surfactants. Alkoxylated amines are available from Huntsman under the trade names Jeffamine® and Surfonamine®. Surfonamine® is an EO/PO amine of particular interest as dispersant and carbon precursor, the PO part allowing carbon generation during pyrolysis.

Fatty alcohol sulfate or phosphate esters, including their zwiterrionic form, are available for example from the Stepan Company. In the specific example of implementation of the present invention, the phosphate esters are preferred. Special attention should be drawn to the styreneoxide-based phosphorylated polyether available form Degussa and of the following formula:

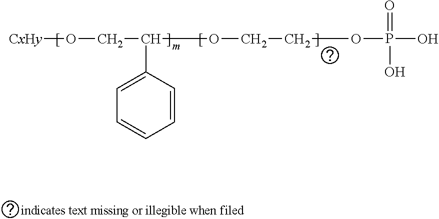

Imidazolium and quaternary ammonium based surfactants are available from Degussa under the trade name Tego Dispersant, for example the compounds of followings formulae:

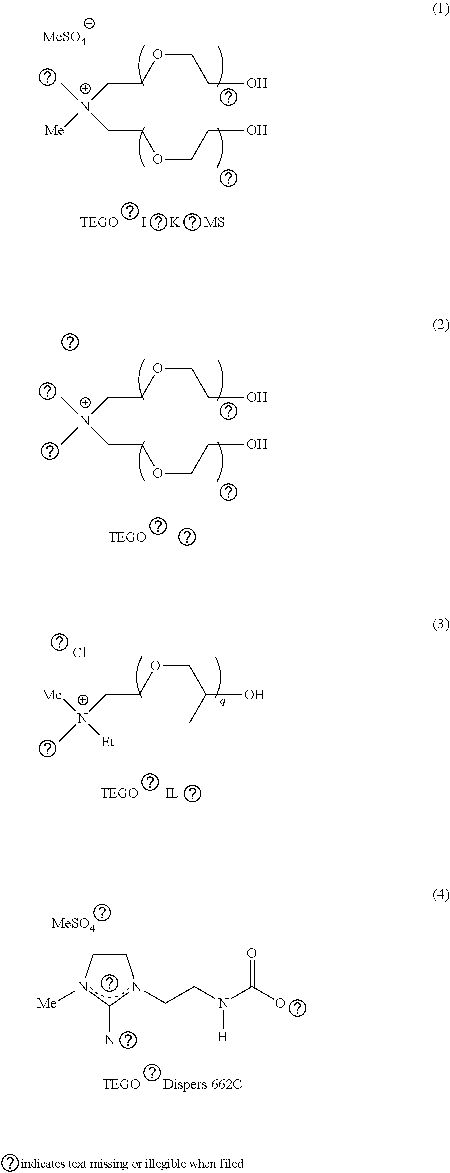

Ethylene oxide/propylene oxide copolymer surfactants are mainly known as Pluronic, the poly oxypropylene part allowing carbon generation during pyrolysis (see for example Chem. Commun., 2003, 1436-1437). Modification of the EO/PO ratio and of the molecular weight provides a large choice of cost-effective surface active agents with tunable properties in terms, surface-tension, wettability, and carbonization ratio. Important physico-chemical data on the Pluronic® products is provided in BASF technical documentation.

Polyanhydride resins obtained by alternate copolymerization of maleic anhydride with an alkylene are also an important class of compounds effective as surface active agent and/or carbon precursor. Of particular interest is poly(maleic anhydride-alt-1-octadecene) available from Chevron Phillips Chemical Company. Mention could also be made of dispersant based on polymer comprising —COOH, —SO₃H, —NH—, —NH₂, —OH substituent and their salt, for example without any limitation polyethyleneimine, polyacrylic acid, polystyrene sulfonate, polyol, polyamine and their derivatives.

Reactive surfactants so called “Surfiner”, are non-ionic, cationic and anionic compounds (see Acta Polym 95, 49, 671). “Reactive surfactant” refers to a surfactant containing a polymerizable group through anionic, cationic or radical polymerization (for instance an epoxyde, allyl, vinyl, acrylate, methacrylate, vinylether, or maleimide group), a condensable group (for example an amine, carboxylic acid, or alcohol group) or a chemically reactive group (for example an isocyanate, blocked isocyanate, carbodiimide, or epoxy group). Typical examples are the compounds of the following formulae:

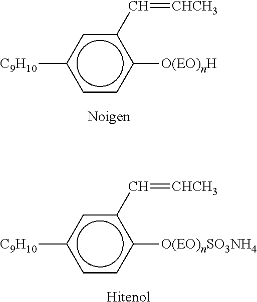

Noigen and Hitenol are available from Dai-ichi Kogyo Seiyaku Co., Ltd (Japan). Other suitable compounds are available from Uniquema under the trade name Maxemul.

The organic precursor may contain elements such as N, P, Si that may remain in the carbonaceous deposit after pyrolysis. Optionally these organic precursors may be present in at least the gas phase in equilibrium with surface distributed organic precursor during the pyrolysis step and able to grow graphite or graphene layers on the surface of the metal phosphate. Optionally, iron, cobalt or nickel catalyst can be present during the pyrolysis process to promote a conductive carbon deposit of graphene or graphitic nature. The metal catalyst may be introduced and distributed also as a metal containing surfactant such as Fe, Co or Ni stearate or oleate.

In one non-limiting embodiment, the processing agent comprises a fatty acid.

In another non-limiting embodiment, the processing agent is also a source of carbon.

In one non-limiting embodiment, the source of carbon is a fatty acid and polyalkylene, fatty acid representing between 10 and 90 wt. % of both products.

In another non-limiting embodiment, the source of carbon is stearic acid and polyalkylene beads.

In another non-limiting embodiment, the source of carbon is stearic acid and polyethylene and/or polypropylene beads.

In another non-limiting embodiment, the source of carbon is stearic acid and polyethylene beads.

In another non-limiting embodiment, the source of carbon represents between about 3 and 30 wt. % of the total weight of other components (A, M and X sources), preferably between about 5 and 20 wt. %, more preferably between about 5 and 10 wt. %.

The inventors have discovered that the process of the invention enables one to reduce production costs and obtain better performance (e.g., capacity, cycle life, etc.). In one non-limiting embodiment, the process of the invention allows the use of precursors having wider specifications, such as but without being limited thereto, larger starting PSD, or which do not require a preliminary milling step or pre-mixing step, etc. In another non-limiting embodiment, the process of the invention allows the use of a carbon source without the use of a solvent thereby reducing cost and safety concerns.

In one non-limiting embodiment, the active material of the invention has a lower specific surface area (BET) while having better performance. BET is an important parameter for battery manufacturers, lower BET allowing easier processability and requiring the use of less solvent for coating.

In one non-limiting embodiment, the active material of the invention has a BET which is less than about 10 m²/g, preferably less than about 9 m²/g, more preferably less than about 8 m²/g, while excluding 0 m²/g.

In one non-limiting embodiment, the active material of the invention has a BET of about 9 m²/g and a carbon content of about less than 2.5 wt. %, i.e. a BET/C ratio of about 3.6. Typically, an alkali metal oxyanion having a carbon deposited by pyrolysis obtained with other known processes having a carbon content of about 2 to 2.5 wt. % would have a BET of about 14-15 m²/g, i.e. a BET/C ratio of about 5.6 to 7.5. Typically, an alkali metal oxyanion having a carbon deposited by pyrolysis obtained with other known processes (e.g. as described in CA 2,307,119, WO 02/027824 or WO 02/027823) has a BET of about 12-13 m²/g and a carbon content of about 1.1-1.5 wt. %, i.e. a BET/C ratio of about 8 to 11.8. This is illustrated in Table 1:

TABLE 1

| | | Embodiments of the |
|---|---|---|
| Parameters | Prior Art processes | invention |
| BET (m²/g) | 12-13 | 8-10 |
| Carbon (%) | 1.1-1.5 | 2-2.5 |
| Tapped density (g/cm³) | 1 | 1.4 |
| Press density (g/cm³) | 1.9 | 2.3 |

In one non-limiting embodiment, the carbon-deposited alkali metal oxyanion electrode material of the invention has a tapped density which is higher than that of a carbon-deposited alkali metal oxyanion electrode material which is obtained according to the prior art. For instance, an illustrative example of a carbon-deposited alkali metal oxyanion electrode material of the invention has a tapped density of about at least 1.4 g/cm³.

In a further non-limiting embodiment, the carbon-deposited alkali metal oxyanion electrode material of the invention has a tapped density which is comprised between 1.2 and 1.6 g/cm³.

In one non-limiting embodiment, the alkali metal oxyanion electrode material, having a carbon deposit of the invention has a press density which is higher than that of an alkali metal oxyanion electrode material having a carbon deposit which is obtained with prior art processes. For instance, the alkali metal oxyanion electrode material having a carbon deposit, according to a specific example of implementation of the invention has a press density of at least about 2.3 g/cm³.

In a further non-limiting embodiment, the carbon-deposited alkali metal oxyanion electrode material of the invention has a press density which is comprised between 2.1 and 2.5 g/cm³.

Available industrial equipment can be used to perform the dry high-energy ball milling step. Suitable high-energy milling equipment is available from Union Process (Akron, Ohio 44313), Zoz GmbH (Weeden, Germany) and SPEX SamplePrep (Metuchen, N.J. 08840), among other possible suppliers. Specific examples of such suitable high-energy milling equipment include, but without being limited thereto, the Attritor® 1-S having 7.6 L process vessel, the Attritor® SD-30 having 200 L process vessel, and the Attritor® SD-50 having 300 L process vessel (Union process), the Simoloyer CM08 (Zoz), and the SPEX 8000D Mixer/Mill—For 115 V/60 Hz operation, the SPEX 8000D-230 Mixer/Mill—For 230 V/50 Hz operation (SPEX SamplePrep).

On the basis of the information provided in this specification, the person skilled in the art should be able to identify suitable industrial equipment that can be used to perform the dry high-energy ball milling step without undue effort.

Any available industrial milling media suitable for battery manufacturing applications may be used. For instance, one may advantageously use Zirconia milling media (ZrO₂) (e.g. sold by Zircoa), including yttrium or cerium stabilized ZrO₂, the impurities of which are inert, Al₂O₃ (e.g. sold by CTI Grinding Media), tungsten carbide, stainless steel (SS) (e.g. sold by Technocon Engineers), etc. Yttrrium or cerium stabilized ZrO₂ milling media is particularly preferred in the present invention, preferably spherical beads of 6 to 12 mm diameter. On the basis of the information provided in this specification, the person skilled in the art should be able to identify suitable milling media that can be used to perform the dry high-energy ball milling step without undue effort.

In a non-limiting embodiment, density of the grinding media is comprised between about 3 to 15 g/cm³, preferably between 4 to 10 g/cm³, more preferably between 5 to 10 g/cm³.

Suitable B/P ratio (expressed as weight of “milling media/precursors” ratio) may be used in the process of the invention. For instance, in one non-limiting embodiment a suitable B/P ratio may be selected between about 5 to about 30, preferably between about 7 and about 15, more preferably between about 8 and about 12, even more preferably about 10. The person skilled in the art will be able to identify a suitable B/P ratio without undue effort and without departing from the present invention.

In a non-limiting example of implementation, the milling time may be set between about 30 nm to about 5 hours, preferably between about 1 and about 3 hours, more preferably about 2 hours.

The milling speed and/or the grinding power will vary according to the nature of the precursors, the milling media and the milling equipment used. The grinding power (kWh) is a function of the materials batch size (kg) to be grinded. In a specific example of implementation, the grinding power is set in the range from about 1 to about 4 kWh/kg, preferably from about 1 to about 3 kWh/kg, more preferably at about 2 kWh/kg.

In one non-limiting embodiment, the carbon-deposited alkali metal oxyanion cathode material of the present invention may comprise at its surface or in the bulk, additives, such as, without any limitation, carbon particles, carbon fibers and nanofibers, carbon nanotubes, graphene, metallic oxides, and any mixture thereof.

In one non-limiting embodiment, said additives represents up to 5 wt. %, preferably from 0.1 to 3 wt. %, most preferably from 0.2 to 2 wt. %, with respect to the total weight of the material.

The advantageous effect of the invention herein described has also been evaluated with the following carbon-deposited alkali metal phosphosilicate including, without any limitation, C—LiFe_{0.9}Zr_{0.1}(PO₄)_{0.8}(SiO₄)_{0.2}, C—LiFe_{0.9}Sn_{0.1}(PO₄)_{0.8}(SiO₄)_{0.2}, C—Li_{0.9}Na_{0.1}FePO₄, C—LiFe_{0.9}Ti_{0.1}(PO₄)_{0.8}(SiO₄)_{0.2}, C—LiMn_{0.675}Fe_{0.275}Mg_{0.05}PO₄, C—LiFe_{0.95}Al_{0.05}(PO₄)_{0.95}(SiO₄)_{0.05} and C—LiFe_{0.95}Mg_{0.05}PO₄, while improving electrochemical performances of those material.

The invention will now be further illustrated by the following non-limiting examples.

### EXAMPLES

### Example 1

### Synthesis of C—LiFePO₄ Agglomerates

834.91 g as-received FePO₄.2H₂O (sold by Budenheim, grade E53-81), 165.09 g as-received Li₂CO₃ (sold by Quadra Chemicals), 50 g micronized polyethylene wax powders (sold by Marcus Oil & Chemical, grade M 5005, average particle size of 5 μm) were charged in an high-energy ball milling vertical agitation Attritor® (Union Process 1-S) containing 10 kg of yttrium-stabilized ZrO₂ beads (10 mm diameter) as milling media. The attritor was then operated at a speed of 350 rpm but stopped after 5 nm because energy consumption of the motor rotating the agitating arms was too high. After opening the attritor, it became apparent that the milling operation is inefficient, as the mixture of precursors remains stuck on the beads and wall of attritor. It has been concluded that attrition under these particular circumstances should preferably be performed in the presence of a processing agent in addition to polyethylene beads to avoid having the mixture of precursors stick thereon. The processing agent may not be necessary depending on the milling equipment and/or reactants used.

Then, 834.91 g as-received FePO₄.2H₂O (sold by Budenheim, grade E53-81), 165.09 g as-received Li₂CO₃ (sold by Quadra Chemicals), 25 g stearic acid (sold by Sigma-Aldrich) and 25 g micronized polyethylene wax powders (sold by Marcus Oil & Chemical, grade M 5005, average particle size of 5 μm) were charged in an high-energy ball milling vertical agitation attritor (Union Process 1-S, process vessel size of 7 liters) containing 10 kg of yttrium-stabilized ZrO₂ beads (10 mm diameter) as milling media. The attritor was then operated during 2 hours at a speed of 350 rpm, corresponding to a 2 kWh grinding power by kilogram of material being grinded (2 kWh/kg), based on running power of electric motors rotating agitating arms. Strong agglomerates of precursors were obtained after attrition. Experiment has been repeated to produce a 30 kg masterbatch with similar results.

The agglomerates were introduced in a rotary kiln at a feed rate of 10 kg/h and the temperature was gradually raised up to 700° C. at the rate of 6° C. per minute. The temperature was maintained for one hour at 700° C. and then the product was cooled over 40 minutes and then discharged in an airtight container under nitrogen. The kiln was continuously flushed with nitrogen throughout the duration of the thermal treatment. Humid nitrogen gas (bubbled in water at 35-40° C.) was injected in the rotary kiln in the middle of the zone corresponding to the 700° C. 1 hour heat treatment step. As-synthesized C—LiFePO₄ (LMP-1) exhibits a level of moisture of 300 ppm (determined using a Computrac Vapor Pro L sold by Arizona Instruments LLC), a BET of 8.6 m²/g (determined using a Micromeritics Tristar 3020a), a carbon content of 2.23 wt. % (determined using a LECO apparatus), a tapped density of 1.4 g/cm³ (determined using a Varian apparatus model “tap density”), and a press density of 2.26 g/cm³ (determined by applying a pressure of 40 psi on agglomerates).

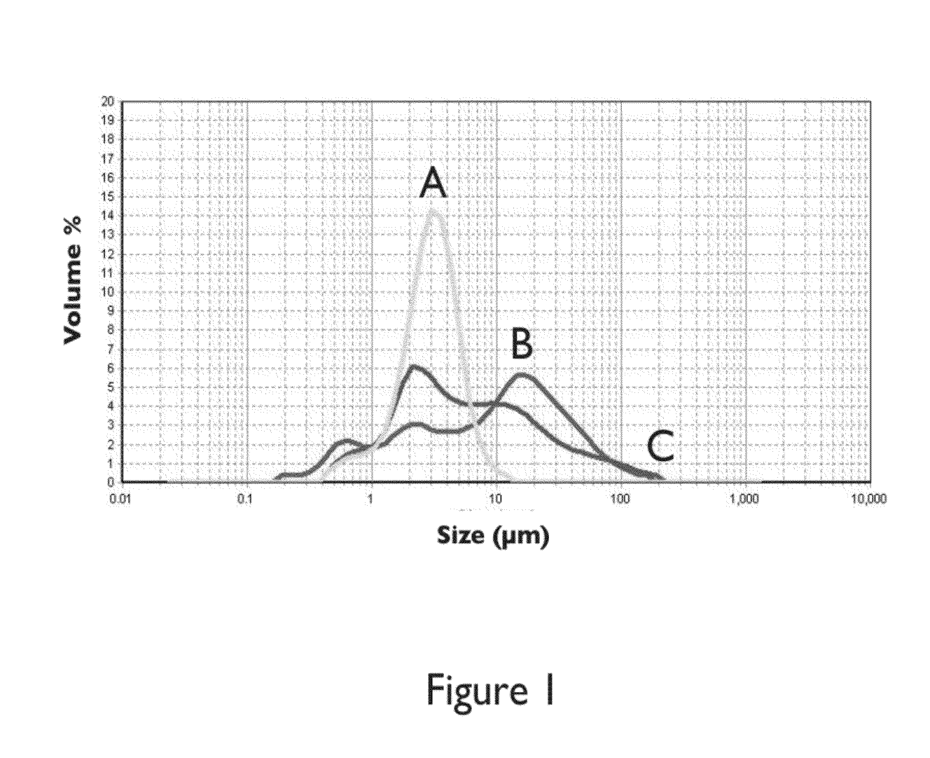

Particle size distribution of FePO₄.2H₂O, agglomerates of precursors obtained after attrition and as-synthesized C—LiFePO₄, determined with a Microtrac S3500 Particle Size Analyser, are provided in FIG. 1 respectively on curve A, B and C.

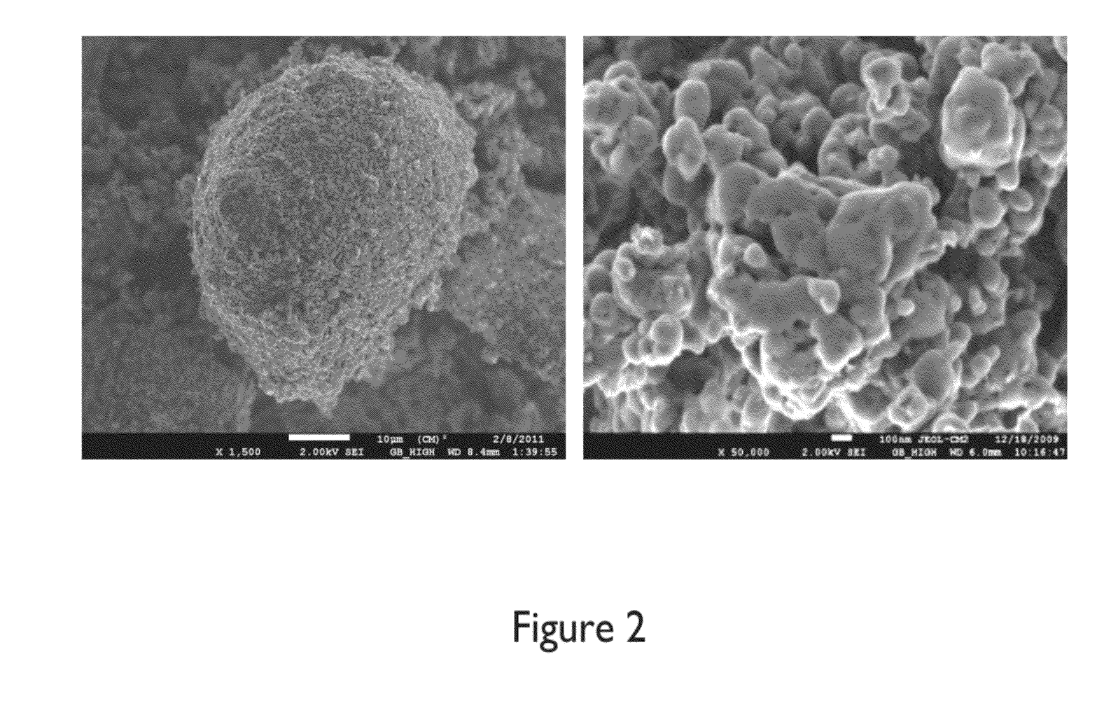

Scanning electron microscopy (SEM) of as-synthesized C—LiFePO₄ is provided on FIG. 2, the product is in the form of large strong agglomerates of submicron carbon-deposited lithium iron phosphate.

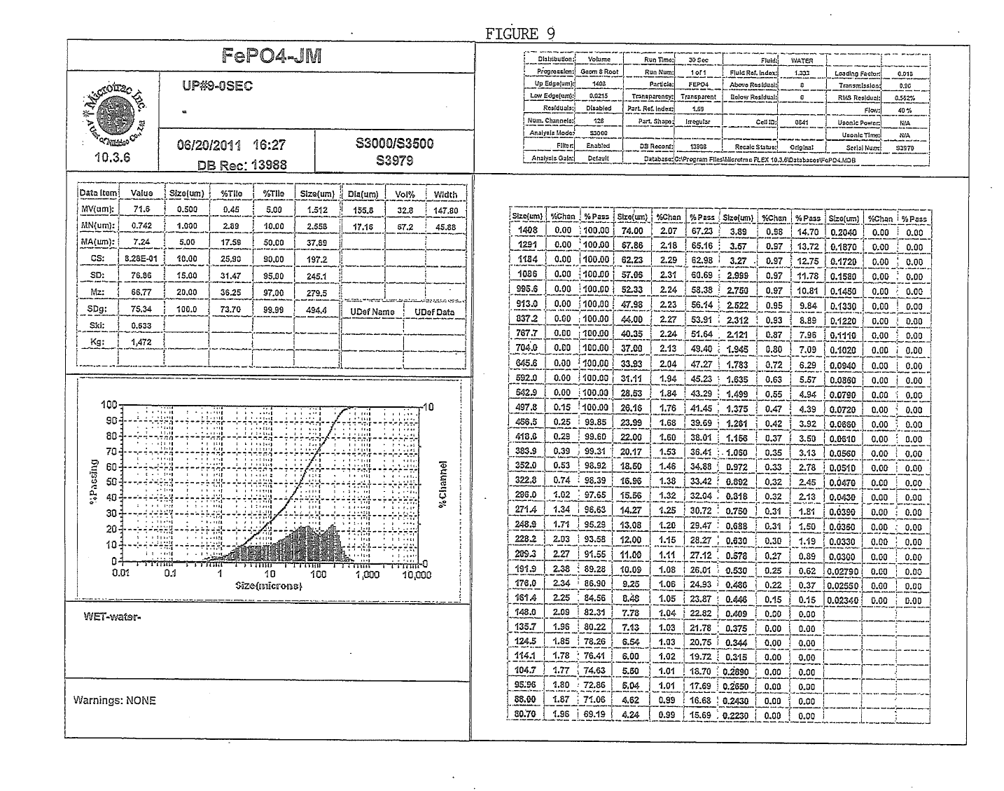

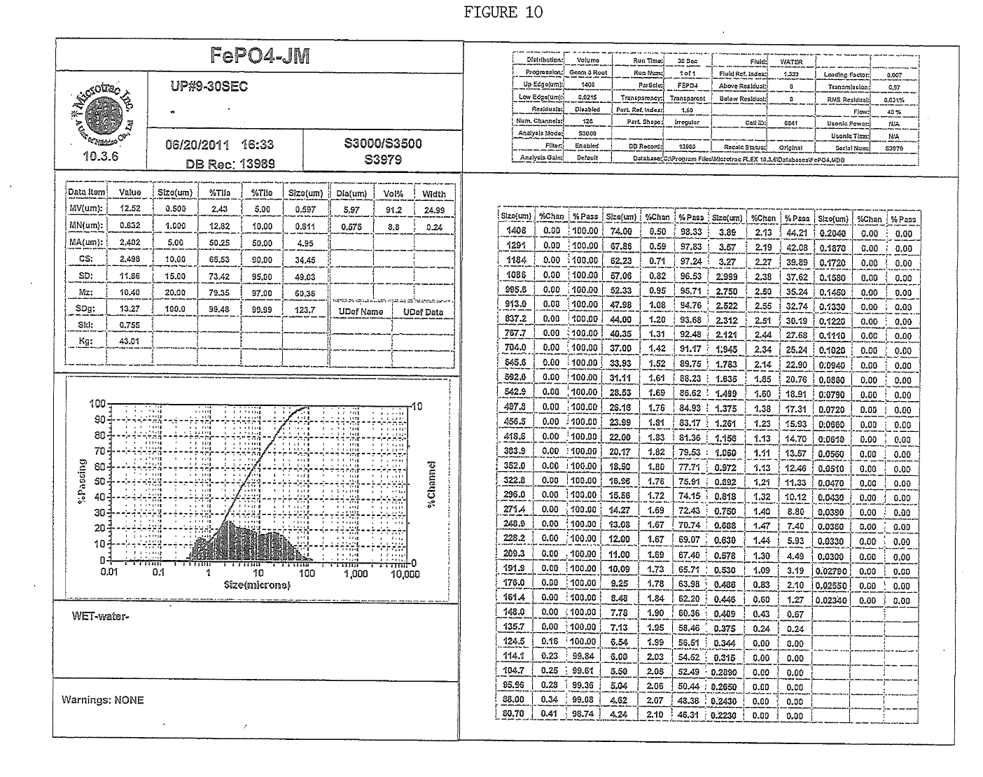

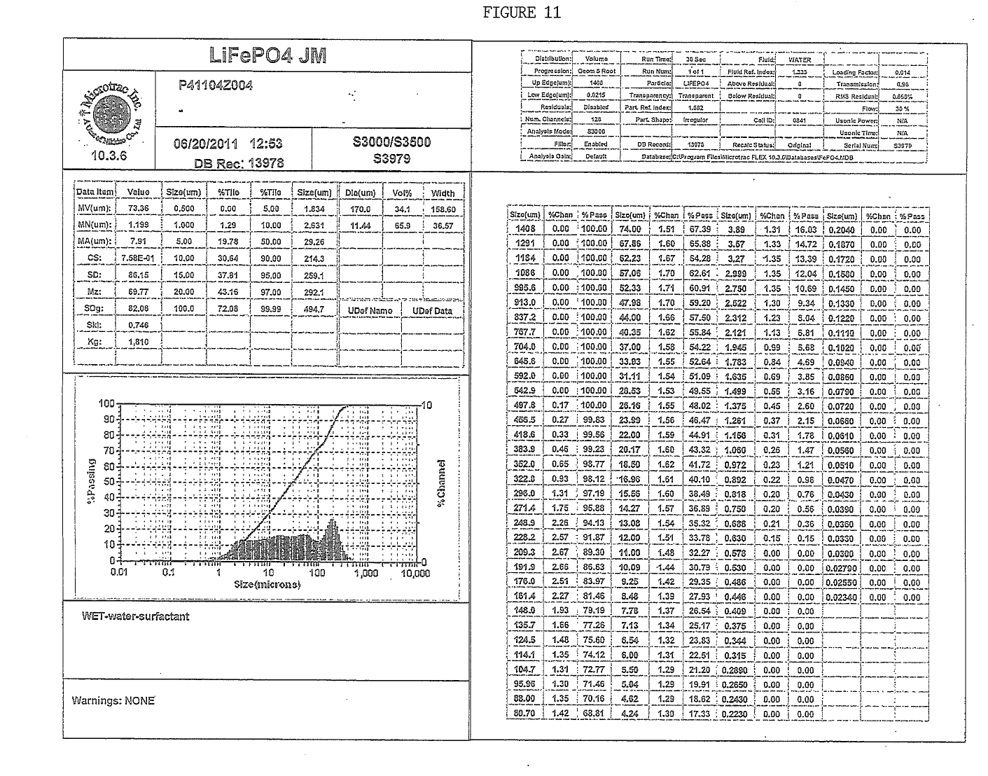

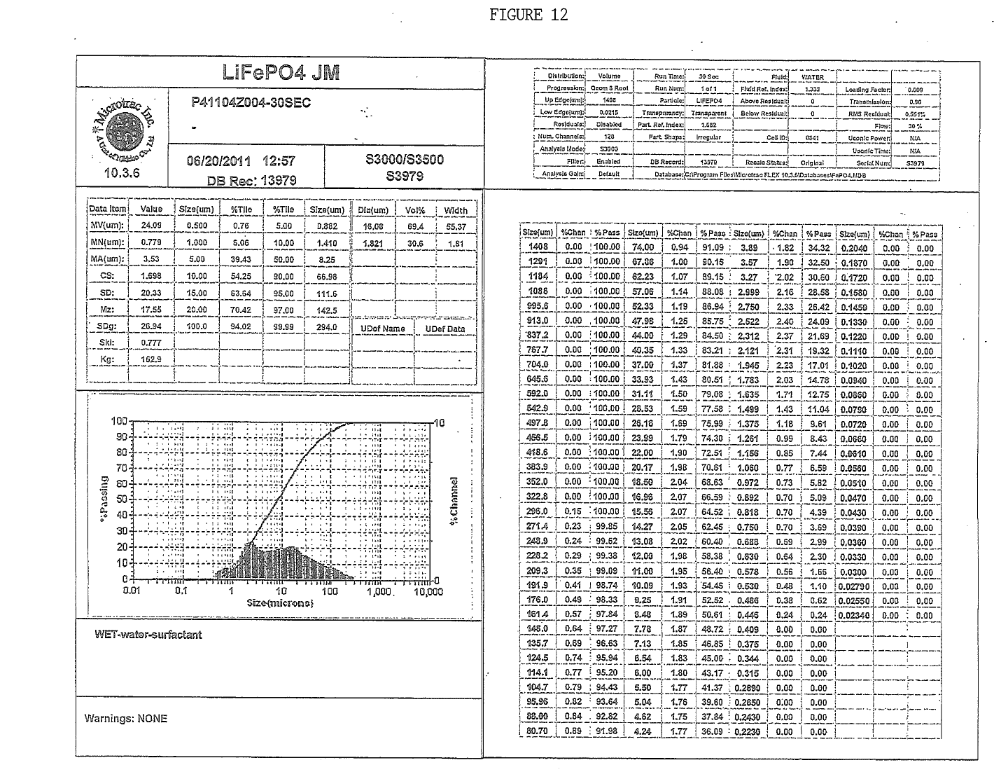

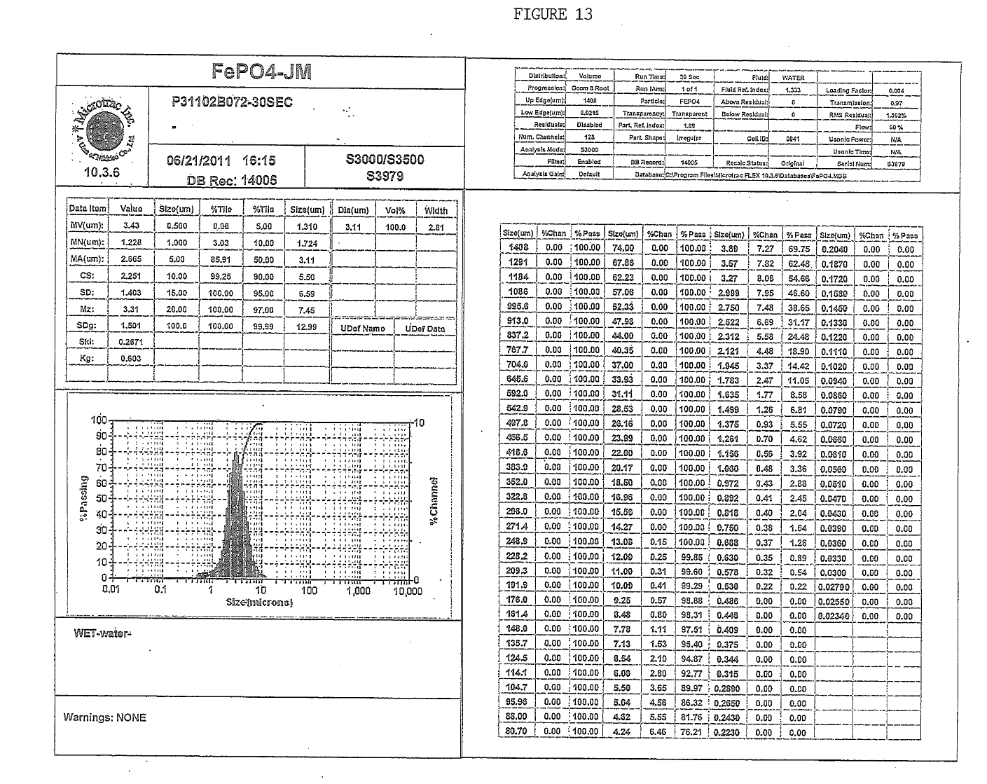

Strength of agglomerates of precursors and of as-synthesized C—LiFePO₄ has been characterized by adding 0.3 g of powder in a 100 ml beaker, then 3 ml of Triton X-100 followed by 60 ml of deionized water, then applying an ultrasonic dispersion energy for 30 s with a Sonic and Materials VCX 130 ultrasonic generator (power 130 W, frequency 20 kHz) equipped with an ultrasonic tip model CV18. References have been made with agglomerates without ultrasonic treatment. A comparative example has been performed on beads of C—LiFePO₄ Life Power® P1 grade (using a simple mixing of precursors in isopropanol followed by drying to obtain beads) obtained just after the thermal step in a rotary kiln in the form of 5 mm mean particle size beads (as observed by SEM). Prior to all PSD measurements, the dispersions are homogenized by agitating at 500 rpm for 20 s. Results are provided in FIGS. 9 to 13.

In this specification, strong agglomerates are thus defined as agglomerates that when subjected to the ultrasonic dispersion treatment above manifest a reduction of D₅₀ of no more than 50-fold, preferably of no more than 30-fold, more preferably of no more than 20-fold, even more preferably of no more than 10-fold.

This process has been repeated in a high-energy milling vertical agitation attritor (Union Process 30SD, process vessel size of 200 liters) with a scale factor of 28 in precursors and yttrium-stabilized ZrO₂ beads (10 mm diameter) quantities. The attritor was then operated during 3 hours at a speed of 150 rpm, corresponding to a 2.5 kWh grinding power by kilogram of material being grinded (2.5 kWh/kg), based on running power of electric motors rotating agitating arms. Strong agglomerates of precursors were obtained after attrition. After heat treatment at 700° C. in a kiln, a similar product to the previous kg-scale synthesis is obtained (LMP-2).

In an airtight container, placed into a furnace and with a gas inlet and outlet, FePO₄.2H₂O/Li₂CO₃/polyethylene beads/stearic acid strong agglomerates (LMP-1 precursor) in a ceramic crucible were heated up to 380° C. for two hours. The airtight container was continuously flushed with dry nitrogen (100 ml/mn) throughout the duration of the heat treatment. After two hours at 380° C., Fe(III) is reduced to Fe(II), in the form of LiFePO₄, by gases generated during pyrolysis of organic precursors (polyethylene beads and stearic acid). The relatively low temperature at which the reduction of Fe(III) to Fe(II) is completed confirms the effectiveness of the high-energy milling.

### Example 2

### Synthesis of C—LiFe_{0.5}Mn_{0.5}PO₄ Agglomerates

454.99 g as-received FePO₄.2H₂O (sold by Budenheim, grade E53-81), 365.04 g as-received MnPO₄ (provided by Shepherd Chemical Company), 179.93 g as-received Li₂CO₃ (sold by Quadra Chemicals), 25 g stearic acid (sold by Sigma-Aldrich) and 25 g micronized polyethylene wax powders (sold by Marcus Oil & Chemical, grade M 5005, average particle size of 5 μm) were charged in an high-energy ball milling vertical agitation attritor (Union Process 1-S) containing 10 kg of yttrium-stabilized ZrO₂ beads (10 mm diameter) as milling media. The attritor was then operated during 2 hours at a speed of 350 rpm, corresponding to a 2 kWh grinding power by kilogram of material being grinded (2 kWh/kg), based on running power of electric motors rotating the agitating arms. Strong agglomerates of precursors were obtained after attrition. The experiment has been repeated with similar results to produce a 30 kg masterbatch.

The agglomerates were introduced in a rotary kiln at a feed rate of 10 kg/h and heat up to 700° C. at the rate of 6° C. per minute. This temperature was maintained for one hour and then the product was cooled over 40 minutes and then discharged in an airtight container under nitrogen. The kiln was maintained under flushing with nitrogen throughout the duration of the heat treatment and humid nitrogen gas (bubbled in water at 35-40° C.) was injected in the rotary kiln in the middle of the zone corresponding to the 700° C. 1 hour heat treatment step. As-synthesized C—LiFe_{0.5}Mn_{0.5}PO₄ (LMP-3) exhibits a level of moisture of 360 ppm and present a similar particle size distribution than LMP-1 material prepared as disclosed in example 1.

The experiment has been repeated with similar results, by replacing 25 g stearic acid (sold by Sigma-Aldrich) and 25 g micronized polyethylene wax powders (sold by Marcus Oil & Chemical, grade M 5005, average particle size of 5 μm) with 20 g stearic acid (sold by Sigma-Aldrich), 20 g micronized polyethylene wax powders (grade M 5005) and 20 gr Pluronic P-123 (Sold by BASF).

### Example 3

### Synthesis of C—LiFePO₄ Agglomerates

Several batches of 834.91 g as-received FePO₄.2H₂O (sold by Budenheim, grade E53-81), 165.09 g as-received Li₂CO₃ (sold by Quadra Chemicals), 25 g stearic acid (sold by Sigma-Aldrich) and 25 g micronized polyethylene wax powders (sold by Marcus Oil & Chemical, grade M 5005, average particle size of 5 μm) were charged in an high-energy ball milling vertical agitation attritor (Union Process 1-S) containing yttrium-stabilized ZrO₂ beads (10 mm diameter) as milling media. Attrition has been performed for different weight of beads to powder being grinded ratio (B/P), milling time and rotating speed of agitating arms, followed by a thermal treatment step at 700° C. as in example 1.

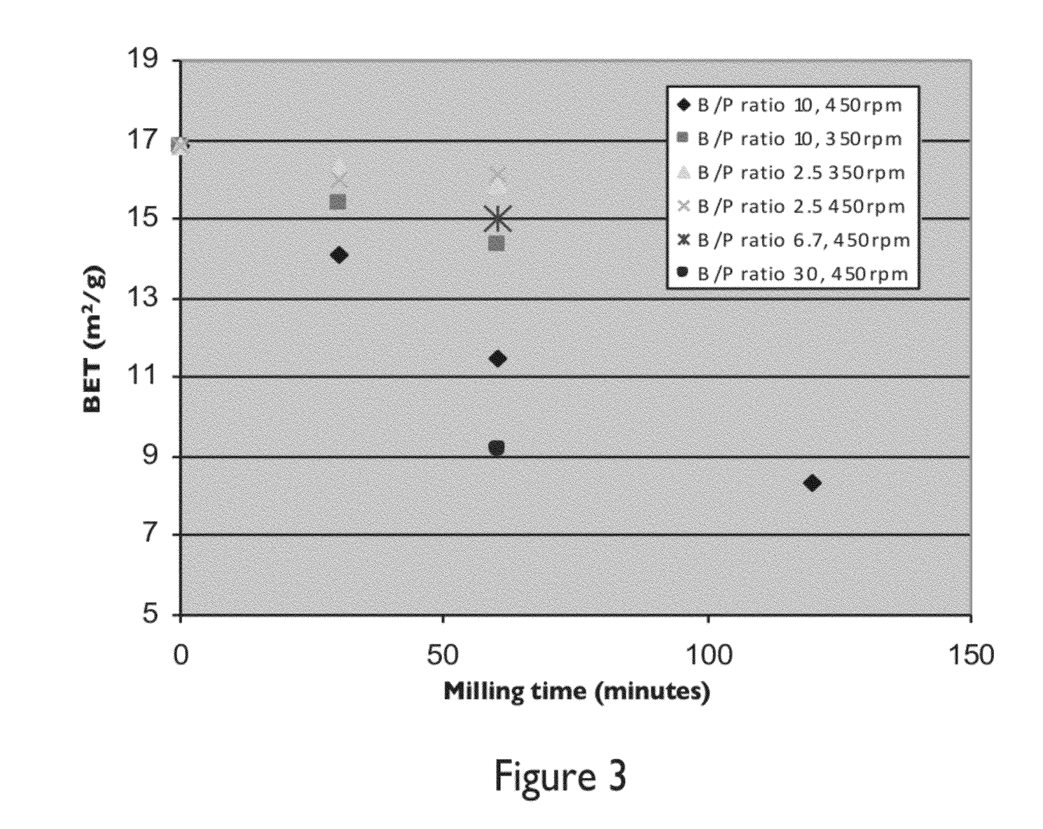

Specific surface area (BET in m²/g), measured with a Micromeritics Tristar 3020, of C—LiFePO₄ cathode material obtained in various milling conditions are provided in FIG. 3. BET could be decreased through increase of milling intensity, the process of the invention allows producing agglomerated C—LiFePO₄ with BET value lower than 10 m²/g with industrial operating conditions. C—LiFePO₄ obtained after 2 hours milling with a B/P ratio of 10 and a rotating speed of 450 rpm is referred as LMP-4.

The first experiment has been repeated by adding 7 g of xGnP®-M-5 graphene nanoplatelets (sold by XG Sciences, USA) to the FePO₄/Li₂CO₃/stearic acid/polyethylene wax powders mixture. As-synthesized cathode material (LMP-6) is in the form of strong agglomerates of submicron carbon-deposited lithium iron phosphate incorporating xGnP®-M-5 graphene nanoplatelets.

The first experiment has been repeated by adding 7 g of VGCF®-H vapor grown fibers (sold by Showa Denko KK, Tokyo, Japan) to the FePO₄/Li₂CO₃/stearic acid/polyethylene wax powders mixture. As-synthesized cathode material is in the form of strong agglomerates of submicron carbon-deposited lithium iron phosphate incorporating VGCF®-H vapor grown fibers.

### Example 4

### Synthesis of C—LiFePO₄ Agglomerates

A mixture comprising 30 kg of FePO₄.2H₂O (sold by Budenheim, grade E53-81) and 1.5 kg of polyethylene-block-poly(ethylene glycol) comprising 50% of ethylene oxide (sold by Aldrich) was prepared and wetted by isopropyl alcohol (60 liters), mixing was carried out for approximately 2 hours and then the solvent was removed.

After drying, the mixture was introduced in a rotary kiln and heated up to 500° C. for 2 hours to produce carbon-deposited Fe₂P₂O₇ (C—Fe₂P₂O₇). The kiln was continuously flushed with nitrogen throughout the duration of the heat treatment.

C—Fe₂P₂O₇ (3 moles), as-received Li₂CO₃ (3 moles, sold by Quadra Chemicals), and 2 wt. % stearic acid (sold by Sigma-Aldrich) were charged in a high-energy ball milling vertical agitation attritor (Union Process 1-S, process vessel size of 7 liters) containing 10 kg of yttrium-stabilized ZrO₂ beads (10 mm diameter) as milling media. The attritor was then operated during 2 hours at a speed of 350 rpm. Strong agglomerates of precursors were obtained after attrition. The experiment was repeated to produce a 20 kg masterbatch with similar results.

The agglomerates were introduced in a rotary kiln at a feed rate of 10 kg/h and heated up to 700° C. at the rate of 6° C. per minute. This temperature was maintained for one hour and then the product was cooled over 40 minutes and then discharged in an airtight container under nitrogen in the form of C—LiFePO₄ agglomerates (LMP-5). The kiln was continuously flushed with nitrogen throughout the duration of the heat treatment and humid nitrogen gas (bubbled in water at 35-40° C.) was injected in the rotary kiln in the middle of the zone corresponding to the 700° C. 1 hour heat treatment step.

### Example 5

### Preparation of Liquid Electrolyte Batteries

Liquid electrolyte batteries were prepared according to the following procedure.

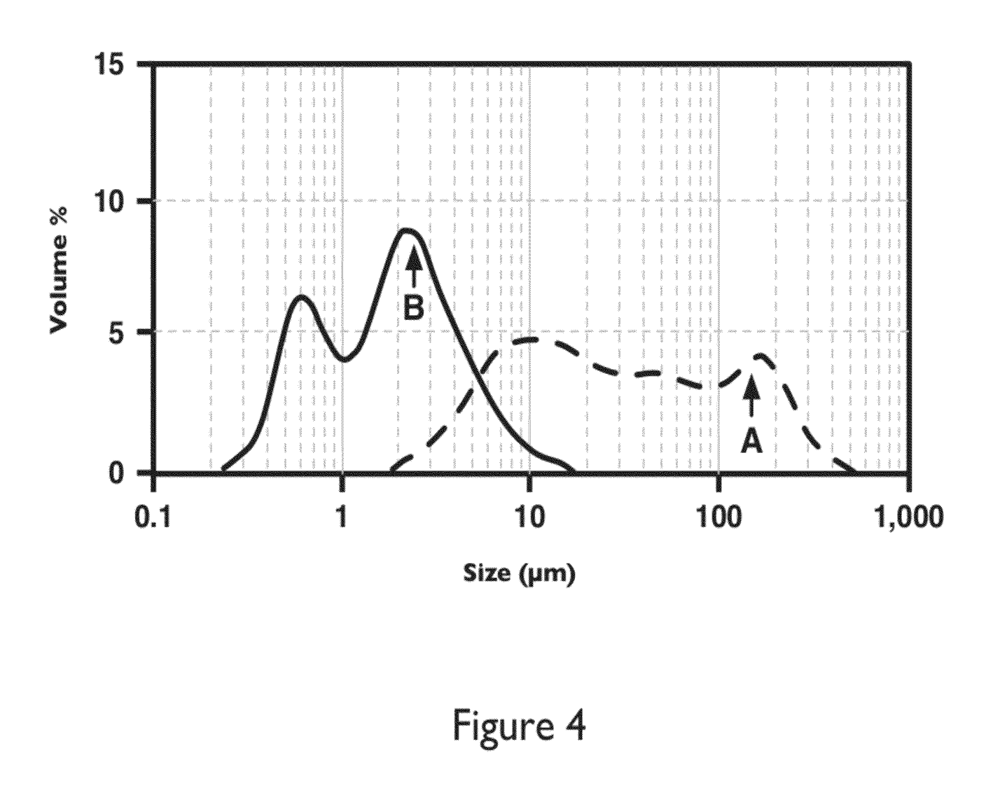

Cathode material of the present invention, HFP-VF₂ copolymer (Kynar® HSV 900, supplied by Atochem) and an EBN-1010 graphite powder (supplied by Superior Graphite) are ball milled in a jar mill with zirconia beads in N-methylpyrrolidone (NMP) for 10 hours in order to prepare a slurry comprising a cathode material with battery grade particle size distribution, and to obtain a dispersion composed of the cathode/HFP-VF₂/graphite 80/10/10 by weight mixture. The mixture obtained was subsequently deposited, using a Gardner® device, on a sheet of aluminum carrying a carbon-treated coating (supplied by Exopack Advanced Coating) and the film deposited was dried under vacuum at 80° C. for 24 hours and then stored in a glovebox. Particle size distribution of as-synthesized LMP-2 C—LiFePO₄ obtained in example 1 (Curve A) and milled alone in jar mill with zirconia media in NMP (Curve B) is provided in FIG. 4.

Batteries of the “button” type were assembled and sealed in a glovebox, use being made of the carbon-treated sheet of aluminum carrying the coating comprising the cathode material of present invention, as battery cathode, a film of lithium, as anode, and a separator having a thickness of 25 μm (supplied by Celgard) impregnated with a 1M solution of LiPF₆ in an EC/DEC 3/7 mixture.

The batteries were subjected to scanning cyclic voltammetry at ambient temperature with a rate of 20 mV/80 s using a VMP2 multichannel potentiostat (Biologic Science Instruments), first in oxydation from the rest potential up to Vₘₐₓ V and then in reduction between Vₘₐₓ and Vₘᵢₙ V. Voltammetry was repeated a second time and nominal capacity of the cathode material (in mAh/g) determined from the second reduction cycle. Nominal capacities obtains for different cathode of present invention are provided in following table, with a commercial C—LiFePO₄ (Phostech Lithium grade P1) as reference:

| Battery cathode | Vₘᵢₙ | Vₘₐₓ | C (mAh/g) |
|---|---|---|---|
| LMP-1 | 2.2 | 3.7 | 153 |
| LMP-2 | 2.2 | 3.7 | 152 |
| LMP-3 | 2.2 | 4.4 | 142 |
| LMP-4 | 2.2 | 3.7 | 155 |
| LMP-5 | 2.2 | 3.7 | 154 |
| P1 | 2.2 | 3.7 | 140 |

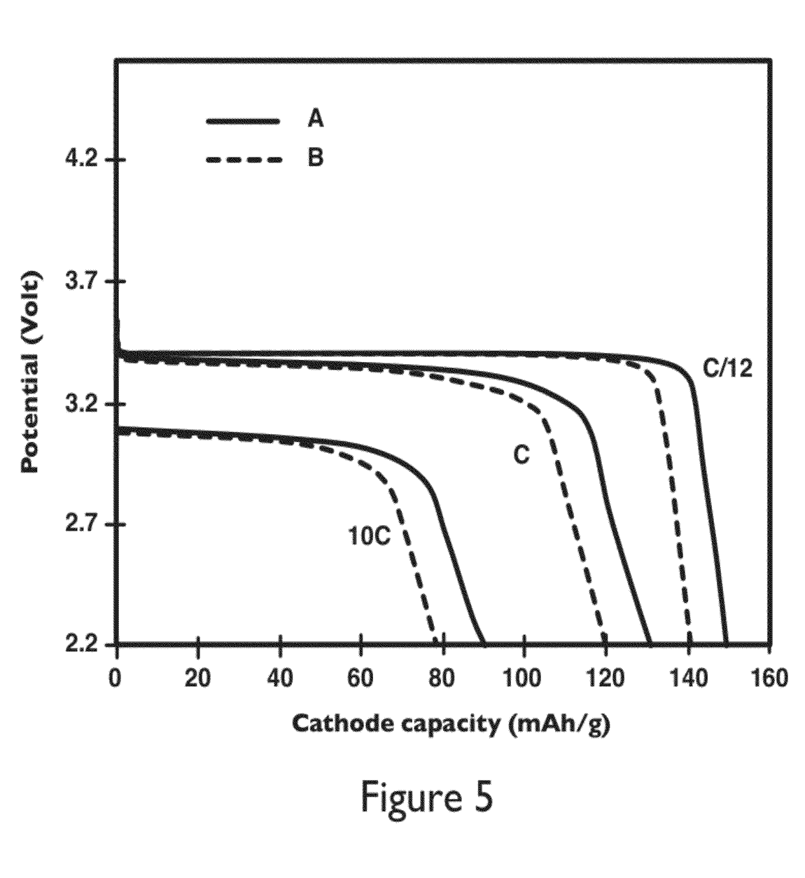

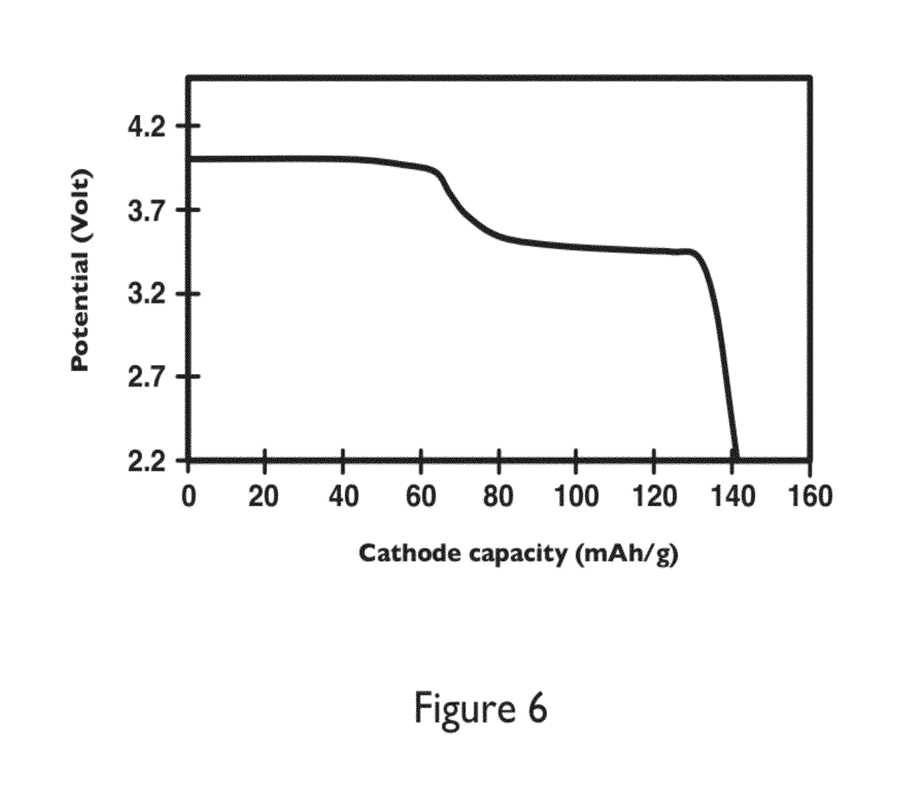

Similar batteries were also tested with intensiostatic discharge between Vₘₐₓ and Vₑₙᵢₙ V at various rate of C/t, t representing time to fully discharge nominal capacity (for example C/10 for a discharge in 10 hours or 10 C for a discharge in 6 nm) at ambient temperature. Discharge curve of LMP-1 cathode material for discharge rate of C/12, C and 10 C is provided on FIG. 5 (Curve A), comparatively with a commercial C—LiFePO₄ P1 grade (Curve B). Discharge curve of LMP-3 material is provided on FIG. 6 for discharge rate of C/12.

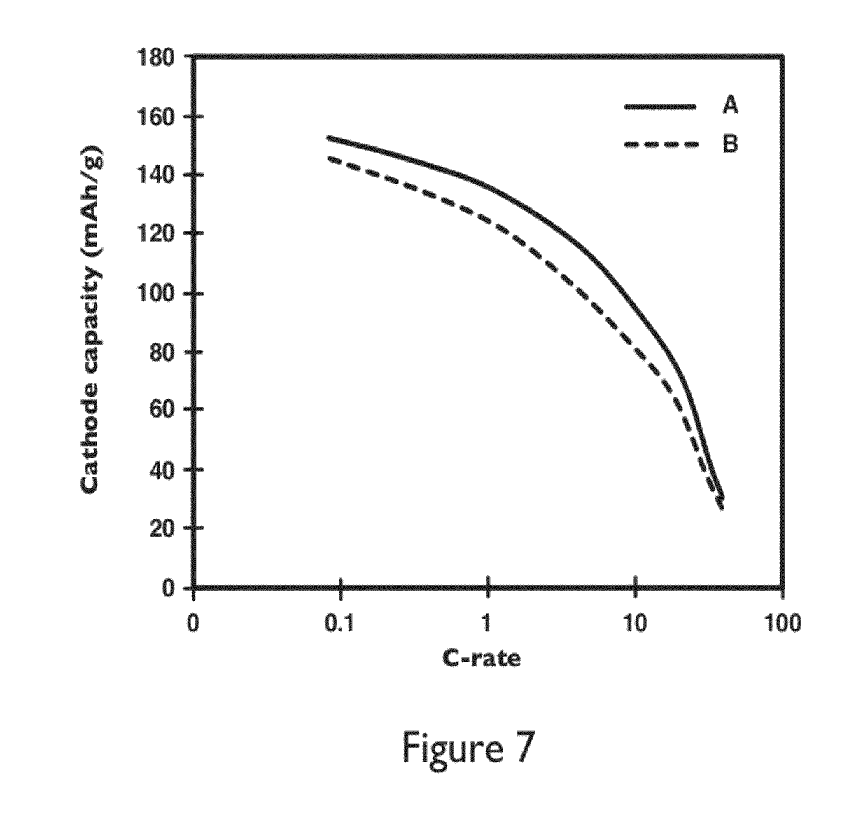

Similar batteries were also tested, at ambient temperature, with intensiostatic discharge between Vₘₐₓ and Vₘᵢₙ V at various rate of discharge, result is illustrated on FIG. 7 as a ragone plot, providing cathode material capacity (mAh/g) depending on rate of discharge (C-rate) for LMP-1 cathode material (Curve A), comparatively with a commercial C—LiFePO₄ P1 grade (Curve B).

Ragone test were also performed with LMP-4 and LMP-6 (153 mAh/g nominal capacity nominal obtained by slow cycling scanning voltammetry) cathode material, it has been observed that at 10 C discharge rate, LMP-6 present an improved discharge capacity (mAh/g) comparatively to LMP-4 of around 8%.

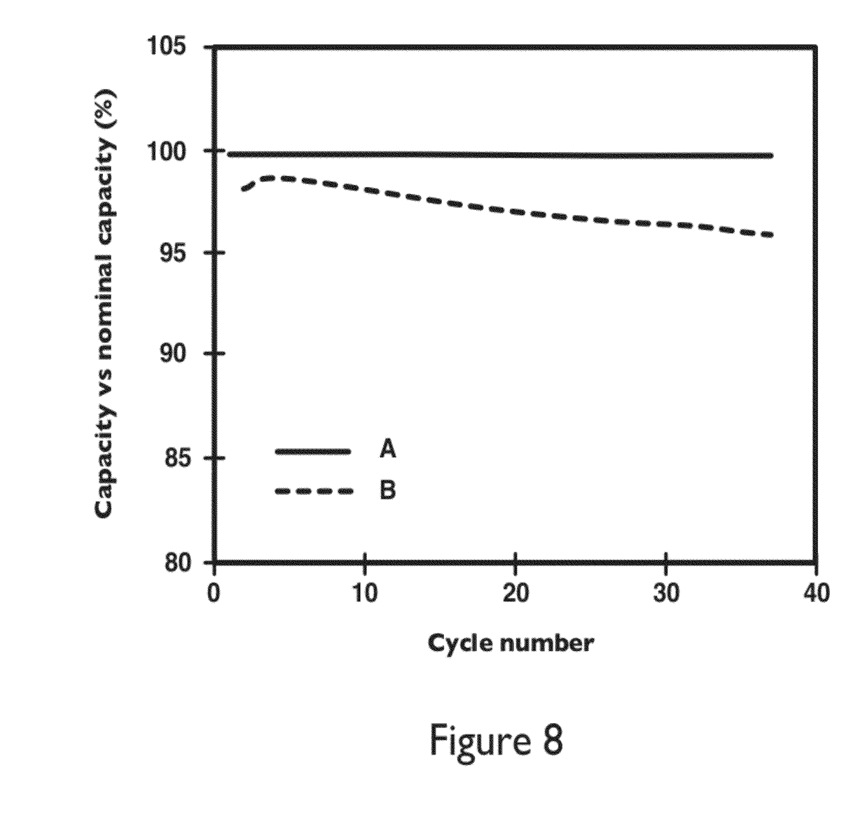

Similar batteries were also tested, at ambient temperature and 60° C., with intensiostatic discharge (C/12) between Vₘₐₓ and Vₘᵢₙ V to evaluate cycling capability. The results are illustrated on FIG. 8 at 60° C. and a C/4 discharge rate, providing cathode material capacity (mAh/g) depending on cycle number for LMP-1 cathode material (Curve A), comparatively with a commercial C—LiFePO₄ P1 grade (Curve B).

Qualification of batteries using C—LiFePO₄ of present invention as cathode material shows that it is possible to achieve a capacity of about 150-155 mAh/g at a discharge rate of C/12, 130-135 mAh/g at a discharge rate of 1 C, 95-100 mAh/g at a discharge rate of 10 C, and a capacity fading at 60° C. of about −1% for 100 cycles.

The advantageous effect of the invention herein described has also been evaluated with other carbon-deposited alkali metal oxyanion including, without any limitation, C—LiFe_{0.65}Mn_{0.3}Mg_{0.05}PO₄, C—LiMn_{0.675}Fe_{0.275}Mg_{0.05}PO₄, C—Li_{0.9}Na_{0.1}FePO₄, C—LiFe_{0.95}Al_{0.05}(PO₄)_{0.95}(SiO₄)_{0.05}, C—LiMnPO₄, C—LiFe_{0.7}Mn_{0.3}(PO₄)_{0.95}(SO₄)_{0.05}, and C—LiFe_{0.95}Mg_{0.05}PO₄, while improving electrochemical performances of those material.

### Example 6

### Synthesis of Carbon Deposited Phosphosilicate Agglomerates

FePO₄.2H₂O (0.4 mole) as a phosphorus (P) and iron source, iron oxalate dihydrate (0.05 mole) as an iron source, Li₂CO₃ (0.25 mole) as a lithium source, tetraethyl orthosilicate Si(OC₂H₅)₄ (0.1 mole) as a silicon (Si) source, Zr(IV) acetate hydroxide (0.05 mole) as a Zr⁴⁺source, at an atomic ratio of Li:Fe:Zr:P:Si=1:0.9:0.1:0.8:0.2, and polymeric Unithox™ 550 (5 wt. % of precursors, manufactured by Baker Hughes) as a carbon source were high-energy milled in a SPEX Mill for about 1 hour. The resulting high-energy milled mixture was then heated at about 300° C. for about 1 hour under nitrogen atmosphere. Gaseous products evolved during this thermal step. The resulting product was then high-energy milled for about one hour with a SPEX Mill to produce an amorphous precursor. The resulting high-energy milled amorphous precursor was then heated at about 550° C. for about 5 hours under nitrogen atmosphere. The experiment has been repeated with similar results by replacing the SPEX Mill with an Attritor® with a bead/precursor ratio of 20:1.

As-synthesized cathode materials is in the form of large strong agglomerates.

### Example 7

### Synthesis of Carbon Deposited Phosphosilicate Agglomerates

Iron oxalate dihydrate (590.11 g) serving as an iron source, Li₂CO₃ (6.38 g) serving as a lithium source, LiH₂PO₄ (340.92 g) serving as a phosphorus (P) and lithium source, tetraethyl orthosilicate Si(OC₂H₅)₄ (35.96 g) serving as a silicon (Si) source, Zr(IV) acetate hydroxide (36.63 g) serving as a Zr⁴⁺source, at an atomic ratio of Li:Fe:Zr:P:Si=1:0.95:0.05:0.95:0.05, stearic acid (13.7 g) and grade M 5005 micronized polyethylene wax powders (13.7 g, manufactured by Marcus Oil & Chemical), both as a carbon source, were charged in a high-energy ball milling vertical agitation Attritor® (Union Process 1-S) containing 10 kg of yttrium-stabilized ZrO₂ beads (10 mm diameter) as milling media. The Attritor® was then operated during 2 hours at a speed of 350 rpm. The resulting high-energy milled mixture was then heated at about 300° C. for about 1 hour under nitrogen atmosphere. Gaseous products evolved during this thermal step. The resulting product was then high-energy milled for about one hour in Attritor® to produce an amorphous precursor. The resulting high-energy milled amorphous precursor was then heated at about 570° C. for about 6 hours under humid nitrogen gas (bubbled in water at around 80° C.), dry nitrogen gas is used during heating step (around 90 nm) and cooling step (around 180 nm). The X-ray spectrum of the resulting carbon-deposited lithium iron zirconium phosphosilicate, provided in FIG. 5, shows a unit cell volume of 291.3 Å³ and no clear formation of impurity phase.

As-synthesized cathode materials is in the form of large strong agglomerates of submicron carbon-deposited lithium iron phosphate.

The experiment has been repeated with similar results, with the following precursors:iron oxalate dihydrate (576.19 g) serving as an iron source, Li₂CO₃ (12.46 g) serving as a lithium source, LiH₂PO₄ (315.36 g) serving as a phosphorus (P) and lithium source, tetraethyl orthosilicate Si(OC₂H₅)₄ (70.23 g) serving as a silicon (Si) source, Zr(IV) acetate hydroxide (35.76 g) serving as a Zr⁴⁺source, at an atomic ratio of Li:Fe:Zr:P:Si=1:0.95:0.05:0.9:0.1, stearic acid (13.7 g) and grade M 5005 micronized polyethylene wax powders (13.7 g, manufactured by Marcus Oil & Chemical), both as a carbon source. The X-ray spectrum of the resulting carbon-deposited lithium iron zirconium phosphosilicate, provided in FIG. 6, shows a unit cell volume of 291.6 A³.

As-synthesized cathode material is in the form of large strong agglomerates of submicron carbon-deposited lithium iron phosphate.

### Example 8

### Synthesis of Carbon Deposited Phosphosilicate Agglomerates

Iron oxalate dihydrate (590.11 g) serving as an iron source, Li₂CO₃ (6.38 g) serving as a lithium source, LiH₂PO₄ (340.92 g) serving as a phosphorus (P) and lithium source, tetraethyl orthosilicate Si(OC₂H₅)₄ (35.96 g) serving as a silicon (Si) source, Zr(IV) acetate hydroxide (36.63 g) serving as a Zr⁴⁺source, at an atomic ratio of Li:Fe:Zr:P:Si=1:0.95:0.05:0.95:0.05, stearic acid (9.13 g) and grade M 5005 micronized polyethylene wax powders (9.13 g, manufactured by Marcus Oil & Chemical), both as a carbon source, were charged in a high-energy ball milling vertical agitation Attritor® (Union Process 1-S) containing 10 kg of yttrium-stabilized ZrO₂ beads (10 mm diameter) as milling media. The Attritor® was then operated during 2 hours at a speed of 350 rpm. The resulting high-energy milled mixture was then heated at about 300° C. for about 1 hour under nitrogen atmosphere. Gaseous products evolved during this thermal step. The resulting product, stearic acid (4.57 g) and grade M 5005 micronized polyethylene wax powders (4.57 g), both as a carbon source, were then high-energy milled for about one hour in Attritor®. The resulting high-energy milled amorphous precursor was then heated at about 570° C. for about 6 hours under humid nitrogen gas (bubbled in water at around 80° C.), dry nitrogen gas is used during heating step (around 90 nm) and cooling step (around 180 nm). Carbon-deposited lithium iron zirconium phosphosilicate was thus obtained.

### Example 9

### Synthesis of C—LiFe_{0.3}Mn_{0.7}PO₄ Agglomerates

1 kg of iron oxalate dihydrate, MnCO₃ and LiH₂PO₄ in a molar ratio of 0.3:0.7:1, 25 g stearic acid and 25 g micronized polyethylene wax powders (sold by Marcus Oil & Chemical, grade M 5005, average particle size of 5 μm) were charged in an high-energy ball milling vertical agitation attritor (Union Process 1-S) containing 10 kg of yttrium-stabilized ZrO₂ beads (10 mm diameter) as milling media. The attritor was then operated during 30 minutes at a speed of 450 rpm. In an airtight container, placed into a furnace and with a gas inlet and outlet, the resulting mixture was heated up to 200° C. for five hours. The airtight container was continuously flushed with dry nitrogen (100 ml/mn) throughout the duration of the heat treatment.

Subsequently, the resulting mixture and 10 wt. % of polystyrene powder (sold by Sigma-Aldrich) were charged in an high-energy ball milling vertical agitation attritor (Union Process 1-S) containing 10 kg of yttrium-stabilized ZrO₂ beads (10 mm diameter) as milling media. The attritor was then operated during 30 minutes at a speed of 450 rpm. In an airtight container, placed into a furnace and with a gas inlet and outlet, the resulting mixture was heated up to 450° C. for two hours, then up to 650° C. for three hours. The airtight container was continuously flushed with dry nitrogen (100 ml/mn) throughout the duration of the heat treatment.

As-synthesized cathode material is in the form of strong agglomerates of submicron carbon-deposited lithium iron manganese phosphate with a D₉₀ of 230 μm and a carbon content of 1.42 wt. %. Electrochemical performance of the cathode material has been evaluated as disclosed in example 5, capacity of the material at a C/12 discharge rate is of 150 mAh/g.

The experiment has been repeated with similar results, by replacing polystyrene beads with 5 wt. % of Licowax® E (sold by Clariant).

### Example 10

### Synthesis of C—LiFe_{0.3}Mn_{0.7}PO₄ Agglomerates

1 kg of iron oxalate dihydrate, MnCO₃ and LiH₂PO₄ in a molar ratio of 0.3:0.7:1, 20 g stearic acid and 50 g micronized polyethylene wax powders (sold by Marcus Oil & Chemical, grade M 5005, average particle size of 5 μm) and 20 g lactose were charged in an high-energy ball milling vertical agitation attritor (Union Process 1-S) containing 10 kg of yttrium-stabilized ZrO₂ beads (10 mm diameter) as milling media. The attritor was then operated during 60 minutes at a speed of 450 rpm. In an airtight container, placed into a furnace and with a gas inlet and outlet, the resulting mixture was heated up to 450° C. for two hours, then up to 650° C. for three hours. The airtight container was continuously flushed with dry nitrogen (100 ml/mn) throughout the duration of the heat treatment.

As-synthesized cathode material is in the form of strong agglomerates of submicron carbon-deposited lithium iron manganese phosphate with a D₉₀ of 260 μm and a carbon content of 2.32 wt. %. Electrochemical performance of the cathode material has been evaluated as disclosed in example 5, capacity of the material at a C/12 discharge rate is of 145 mAh/g.

This experiment has been repeated with similar results, with 1 kg of iron oxalate dihydrate, MnCO₃, LiH₂PO₄, MgCO₃ and ZnCO₃ in a molar ratio of 0.27:0.67:1:0.03:0.03, 20 g stearic acid, 50 g micronized polyethylene wax powders (sold by Marcus Oil & Chemical, grade M 5005, average particle size of 5 μm) and 20 g lactose. As-synthesized cathode material is in the form of strong agglomerates of submicron carbon-deposited lithium iron manganese magnesium zinc phosphate.

The first experiment has been repeated with similar results, by replacing 20 gr of lactose with 20 gr of glycerol.

The first experiment has been repeated with similar results, by replacing 20 g stearic acid by 30 g Struktol® V-Wax E (Sold by Struktol, USA).

The carbon-deposited alkali metal phosphosilicate cathode material of the present invention can be optimized by optimizing the precursors' ratios. While the inventors noticed that a possible resulting theoretical chemical formula may slightly depart from electroneutrality, without being bond by any theory, it is believed that the carbon-deposited alkali metal phosphosilicate cathode material of the present invention may contain different phases that balance out the material overall charge in order to ultimately obtain overall electroneutrality. Hence, the present invention is not limited to any defined theoretical chemical formula since the person skilled in the art will understand how to optimize the precursors' ratios in order to obtain the desired carbon-deposited alkali metal phosphosilicate cathode material of the present invention without departing from the invention.

Although the present invention has been described in considerable detail with reference to certain embodiments thereof, variations and refinements are possible without departing from the spirit of the invention. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

All references cited throughout the specification are hereby incorporated by reference in their entirety.

1. A process for preparing a carbon-deposited alkali metal oxyanion electrode material, said process comprising:
a dry milling step of precursors of the alkali metal oxyanion electrode material at an energy sufficient to cause the precursors to agglomerate into strong agglomerates, and
a heating step comprising pyrolysis of an organic source to obtain the carbon-deposited alkali metal oxyanion electrode material.

2. The process of claim 1, wherein said milling step is a high-energy ball milling step.

3. The process of claim 1, wherein said precursors comprise a metal source and the oxidation state of at least one metal ion of the metal source is reduced under heat without full reduction to an elemental state.

4. The process of claim 1, wherein said precursors comprise an Fe(III) source and the heating step comprises a reducing step for reducing the Fe(III) to Fe(II) without full reduction to an elemental state.

5. The process of claim 3, wherein said precursors comprise a reducing agent source.

6. The process of claim 5, wherein said reducing agent source is the organic source.

7. The process of claim 5, wherein said reducing agent source or said organic source is a solid, semi-solid, liquid or waxy hydrocarbon or derivatives thereof or carbonaceous product.

8. The process of claim 4, wherein said reducing step comprises reducing the Fe(III) to Fe(II) in the presence of a reducing agent which participates in reducing the Fe(III) to Fe(II) without full reduction to an elemental state.

9. The process of claim 8, wherein said reducing agent is a reducing atmosphere.

10. The process of claim 1, wherein the precursors comprise an Fe(III) source and a reducing agent and the heating step comprises reducing the Fe(III) to Fe(II) in the presence of the reducing agent which participates in reducing the Fe(III) to Fe(II) without full reduction to an elemental state.

11. The process of claim 4, wherein said Fe(III) source comprises an M′PO₄ compound hydrated or not, wherein M′ comprises Fe(III), optionally having a carbon-deposit.

12. The process of claim 11, wherein M′ comprises FePO₄.

13. The process of claim 11, wherein said precursors further comprise Li₂CO₃.

14. The process of claim 4, wherein said reducing step is conducted at a temperature within the range of about 300° C. to about 750° C.

15. The process of claim 1, wherein said precursors comprise an Fe(II) source.

16. The process of claim 15, wherein said Fe(II) source comprises an M″₂P₂O₇, wherein M″ comprises Fe(II), optionally having a carbon-deposit.

17. The process of claim 15, wherein said Fe(II) source comprises Fe₂P₂O₇ or C—Fe₂P₂O₇ wherein the C— represents a carbon deposit obtained by pyrolysis.

18. The process of claim 15, wherein said organic source is a solid, semi-solid, liquid, or waxy hydrocarbon or derivatives thereof or carbonaceous product.

19. The process of claim 15, wherein said precursors further comprise Li₂CO₃.

20. The process of claim 15, wherein said heating step is conducted at a temperature within the range of about 300° C. to about 750° C.

21. The process of claim 1, wherein:
said strong agglomerates have a D₉₀ size which is between 50 μm and 500 μm, preferably between 100 μm and 300 μm, more preferably between 100 μm and 200 μm; or a D₉₇ size which is between about 50 μm and about 500 μm, preferably between about 100 μm and about 300 μm, more preferably between about 100 μm and about 200 μm; or a size D₉₀≧50 μm, preferably D₉₀≧100 μm, even more preferably D₉₀≧150 μm; or a size D₉₇≧50 μm, preferably D₉₇≧100 μm, even more preferably D₉₇≧150 μm; or
said strong agglomerates comprise particles which have a size of between about 10 nm and about 500 nm, preferably between about 50 nm and about 300 nm, more preferably between about 100 nm and about 200 nm; or particles which have a D₅₀ size which is between about 10 nm and about 500 nm, preferably between about 50 nm and about 300 nm, more preferably between about 100 nm and about 200 nm.

22. The process of claim 1, wherein said milling step is performed at a grinding power (kWh) as a function of the materials batch size (kg) selected in a range from about 1 to about 4 kWh/kg, preferably from about 1 to about 3 kWh/kg, and more preferably is performed at about 2 kWh/kg.

23. The process of claim 1, wherein said carbon-deposited alkali metal oxyanion has the general nominal formula AₐMₘ(XO₄)ₓ, wherein:
A represents Li, alone or partially replaced by at most 20% as atoms of Na and/or K, and 0<a≦8;
M comprise at least 50% at. of Fe(II), or Mn(II), or a mixture thereof, and 1≦m≦3; and
XO₄ represents PO₄, alone or partially replaced by at most 30 mol % of SO₄ or SiO₄, and 0<×s 3; and
wherein M, X, a, m and x are selected as to maintain electroneutrality of said material.

24. The process of claim 1, wherein said carbon-deposited alkali metal oxyanion electrode material has the general nominal formula AₐMₘ(XO₄)ₓ, wherein:
A represents Li, alone or partially replaced by at most 10% as atoms of Na or K, and 0<a≦8;
M is selected from the group consisting of Fe(II), Mn(II), and mixture thereof, alone or partially replaced by at most 50% as atoms of one or more other metals selected from Ni and Co, and/or by at most 20% as atoms of one or more aliovalent or isovalent metals other than Ni or Co, and/or by at most 5% as atoms of Fe(III), and 1≦m≦3; and
XO₄ represents PO₄, alone or partially replaced by at most 10 mol % of at least one group chosen from SO₄ and SiO₄, and 0<×s 3; and
wherein M, X, a, m and x are selected as to maintain electroneutrality of said material.

25. The process of claim 1, wherein said carbon-deposited alkali metal oxyanion electrode material has the general nominal formula AₐMₘ(XO₄)ₓ, wherein:
A represents Li, alone or partially replaced by at most 10% as atoms of Na or K, and 0<a≦8;
M is selected from the group consisting of Fe(II), Mn(II), and mixture thereof, alone or partially replaced by at most 50% as atoms of one or more other metals chosen from Ni and Co, and/or by at most 15% as atoms of one or more aliovalent or isovalent metals selected from the group consisting of Mg, Mo, Nb, Ti, Al, Ta, Ge, La, Y, Yb, Cu, Sm, Ce, Hf, Cr, Zr, Bi, Zn, Ca, B and W, and/or by at most 5% as atoms of Fe(III); and 1≦m≦3; and
XO₄ represents PO₄, alone or partially replaced by at most 10 mol % of SO₄ or SiO₄, and 0<x≦3; and
wherein M, X, a, m and x are selected as to maintain electroneutrality of said material.

26. The process of claim 1, wherein said carbon-deposited alkali metal oxyanion electrode material has the general nominal formula AₐMₘ(XO₄)ₓ, wherein:
A represents Li, alone or partially replaced by at most 10% as atoms of Na or K, and 0<a≦8;
M is selected from the group consisting of Fe(II), Mn(II), and mixture thereof, alone or partially replaced by at most 10% as atoms of one or more other metals chosen from Ni and Co, and/or by at most 10% as atoms of one or more aliovalent or isovalent metals selected from the group consisting of Mg, Mo, Nb, Ti, Al, Ta, Ge, La, Y, Yb, Cu, Sm, Ce, Hf, Cr, Zr, Bi, Zn, Ca, B and W, and/or by at most 5% as atoms of Fe(III); and 1≦m≦3; and
XO₄ represents PO₄, alone or partially replaced by at most 10 mol % of at least one group chosen from SO₄ and SiO₄, and 0<×s 3; and
wherein M, X, a, m and x are selected as to maintain electroneutrality of said material.

27. The process of claim 1, wherein said carbon-deposited alkali metal oxyanion electrode material has the general nominal formula AₐMₘ(XO₄)ₓ, wherein:
A represents Li, alone or partially replaced by at most 20% as atoms of Na and/or K, and 0<a≦8;
M comprise at least 90% at. of Fe(II), or Mn(II), or a mixture thereof, and 1≦m≦3; and
M further comprise at least one +4 valency metal; and
XO₄ represents a phosphosilicate ([SiO₄]ᵥ[PO₄]_{w}), and 0.02≦v/(v+w)≦0.2; and
wherein M, X, a, m and x are selected as to maintain electroneutrality of said material.

28. The process of claim 1, wherein said carbon-deposited alkali metal oxyanion electrode material has the general nominal formula LiMPO₄, wherein M comprises at least 50% at., preferably at least 80% at., more preferably at least 90% at. of Fe(II), or Mn(II), or a mixture thereof.

29. The process of claim 1, wherein said carbon-deposited alkali metal oxyanion electrode material has the general nominal formula LiMPO₄, wherein M comprises at least 65% at. of Mn(II) and at least 25% at. of Fe(II).

30. The process of claim 1, wherein said carbon-deposited alkali metal oxyanion electrode material has the general nominal formula LiFePO₄.

31. The process of claim 1, wherein said milling step is performed in the presence of a processing agent.

32. The process of claim 31, wherein said processing agent comprises carbon.

33. The process of claim 31, wherein said processing agent is a source of carbon.

34. The process of claim 31, wherein said processing agent comprises a surface active agent.

35. The process of claim 31, wherein said processing agent is selected from the group consisting of fatty acid and their derivatives.

36. The process of claim 1, wherein said organic source is selected from the group consisting of stearic acid, fatty acid, polyethylene, polyalkylene, polypropylene, and mixtures thereof.

37. The process of claim 1, wherein said electrode material has a tapped density comprised between 1.2 and 1.6 g/cm³.

38. The process of claim 1, wherein said carbon-deposited electrode material is in the form of strong agglomerates.

39. The process of claim 38, wherein said strong agglomerates of the carbon-deposited electrode material are further milled to a suitable battery particle size distribution.

40. The process of claim 1, wherein said milling step of precursors comprises use of Zirconia milling media (ZrO₂), preferably yttrium or cerium stabilized ZrO₂.

41. The process of claim 1, wherein said milling step of precursors comprises use of milling media at a B/P ratio expressed as weight of milling media/precursors ratio selected between about 5 to about 30, preferably between about 7 and about 15, more preferably between about 8 and about 12, even more preferably about 10.

42. The process of claim 1, wherein said milling step is performed in the presence of a processing agent which is a surface active agent.

43. The process of claim 1, wherein said cathode material has a press density which is comprised between 2.1 and 2.5 g/cm³.

44. The process of claim 1, wherein said heating step comprises a reducing step which is performed at a temperature of less than 400° C. held for at least one hour in the presence of a reducing agent source.

45. The process of claim 1, wherein said heating step comprises a reducing step which is performed at a temperature of about 380° C. held for at least one hour in the presence of a reducing agent source.

46. The process of claim 1, wherein said material comprises an additive selected from carbon particles, carbon fibers or nanofibers, carbon nanotubes, graphene, metallic oxides, and any mixture thereof.

47. The process of claim 46, wherein said additive is present on a surface of said material.

48. The process of claim 46, wherein said additive represents up to 5 wt. %, preferably from 0.1 to 3 wt. %, most preferably from 0.2 to 2 wt. %, with respect to the total weight of the material.
